(19) United States
(12) Patent Application Publication
(10) Pub. No.: US 2020/0013002 A1
(43) Pub. Date: Jan. 9, 2020

(54) WEIGHT MEASURING DEVICE AND STOCK CONTROL SYSTEM

(71) Applicant: Smart Shopping, Inc., Tokyo (JP)

(72) Inventors: Hidetoshi HAYASHI, Tokyo (JP); Keiichiro NAGASHIMA, Tokyo (JP)

(73) Assignee: Smart Shopping, Inc., Tokyo (JP)

(21) Appl. No.: 16/236,658

(22) Filed: Dec. 31, 2018

Related U.S. Application Data
(63) Continuation of application No. PCT/JP2018/041725, filed on Nov. 9, 2018.

(30) Foreign Application Priority Data
Jul. 3, 2018 (JP) 2018-127027

(51) Int. Cl. G06Q 10/08; G06Q 10/06; G06Q 30/06; G08B 21/18; G01G 21/22; G01G 23/18

(52) U.S. Cl. CPC G06Q 10/087; G06Q 10/06315; G06Q 30/0633; G06F 3/0482; G01G 21/22; G01G 23/18; G08B 21/182

(57) ABSTRACT

A weight measuring device that includes a housing having a flat panel shape, a weight sensor that measures a weight of a product placed on a top of the housing, a memory that stores address information of an address of a server on a network, and processing circuitry that wirelessly communicates with the server on the network, acquires measurement data from the weight sensor, and sends the acquired measurement data to the server using the address information stored in the memory.

### CROSS REFERENCE TO RELATED APPLICATIONS

This application is a continuation of National Stage Application based on PCT/JP2018/41725, filed on Nov. 9, 2018, and claims priority to and benefit of the filing date of Japanese patent application No. 2018-127027, filed on Jul. 3, 2018, which is hereby incorporated by reference in its entirety.

### TECHNICAL FIELD

The present disclosure relates to a weight measuring device and a stock control system.

### BACKGROUND

Patent Document 1 discloses that a remaining water quantity control device measures the weight of a water dispenser placed thereon, checks the quantity of water remaining in a water tank based on the measurement value, and automatically orders a new water tank based on the remaining quantity.

### CITATION LIST

### Patent Document

Patent Document 1: Japanese Unexamined Patent Publication No. 2016-167159

### SUMMARY

The present application provides, for example, a weight measuring device, comprising: a housing having a flat panel shape; a weight sensor configured to measure a weight of a product placed on a top of the housing; a memory configured to store address information of an address of a server on a network; and processing circuitry configured to wirelessly communicate with the server on the network; acquire measurement data from the weight sensor; and send the acquired measurement data to the server using the address information stored in the memory.

### BRIEF DESCRIPTION OF THE DRAWINGS

FIG. 1 illustrates an example of a configuration of a stock control system according to an embodiment.

FIG 2 illustrates an example of a configuration of a weight measuring mat.

FIG. 3 illustrates an example of a configuration of a server.

FIG. 4 illustrates an example of a configuration of a terminal device.

FIG. 5 illustrates an example of relationship among the weight measuring mat, a product, and location information.

FIG. 6 illustrates a state where a single product is placed on two weight measuring mats.

FIG. 7 is a flowchart illustrating an example of how the stock control system according to an embodiment generates a remaining quantity alert.

FIG. 8 is a flowchart illustrating an example of a step of calculating a proper stock quantity.

FIG. 9 illustrates an example of a screen showing locations of products on a layout plan and the remaining quantities of the products depicted at their locations.

FIG. 10 illustrates an example of a screen showing the remaining quantities of the products sorted by area.

FIG. 11A is a flowchart illustrating an example of how the stock control system according to an embodiment generates a dead stock alert.

FIG. 11B is a flowchart illustrating an example of how the stock control system according to an embodiment generates a dead stock alert.

FIG. 12 is a flowchart illustrating an example of a step of calculating an upper limit value of proper stock days.

FIG. 13 illustrates a breakdown of the remaining quantity of the product by replenishment day.

FIG. 14 illustrates an example of a screen showing locations of products on a layout plan and the maximum stock days of the products depicted at their locations.

FIG. 15 illustrates an example of a screen showing the maximum stock days of the products sorted by area.

FIG. 16 illustrates an example of a history of the remaining quantity.

### DETAILED DESCRIPTION

### Technical Problem

The remaining water quantity control device according to Patent Document 1 is placed below the water dispenser to measure the weight of the water dispenser. In other words, the control device is customized to the water dispenser which is a particular product. Therefore, the remaining water quantity control device of Patent Document 1 does not have general-purpose properties because the type of products to be measured matters. Further, the remaining water quantity control device of Patent Document 1 is connected to a commercial AC power supply for use (see paragraph 0014), and thus, is usable only within a reach of a cable extending from the commercial AC power supply. That is, this control device has no general-purpose properties because the installation site also matters.

In view of the foregoing background, the present disclosure has been achieved. The present disclosure aims to provide a general-purpose weight measuring device which can be used for stock control, and a stock control system including the weight measuring device.

### Solution to the Problem

A first aspect of the present disclosure is directed to a general-purpose weight measuring device, which is usable for stock control.

According to this aspect, a general-purpose weight measuring device usable for stock control can be provided.

A second aspect of the present disclosure is an embodiment of the first aspect. In the second aspect, the weight measuring device is configured as a weight measuring mat.

A third aspect of the present disclosure is an embodiment of the second aspect. In the third aspect, the weight measuring device is in the shape of a flat panel.

In this aspect, the weight of any product can be measured as long as the product can be placed on the flat panel-shaped weight measuring device. This can provide the weight measuring device with remarkable general-purpose properties because the type of products to be measured does not matter.

A fourth aspect of the present disclosure is an embodiment of the second or third aspect. In the fourth aspect, the weight measuring device has a planar shape in accordance with a particular standard.

In this aspect, a plurality of weight measuring devices can be easily placed in combination in a planar direction, which enhances the general-purpose properties of the weight measuring device.

A fifth aspect of the present disclosure is an embodiment of the fourth aspect. In the fifth aspect, the weight measuring device includes a plurality of weight measuring devices which are able to be combined together in a planar direction.

In this aspect, combining a plurality of weight measuring devices in the planar direction makes it possible to measure the weight of a product, even if it is large in size. This can enhance the general-purpose properties of the weight measuring device because the type of products to be measured does not matter.

A sixth aspect of the present disclosure is an embodiment of any one of the first to fifth aspects. In the sixth aspect, the weight measuring device includes: a housing which is in the shape of a flat panel; a weight sensor which measures a weight of a product placed on a top of the housing; a memory which stores a set value of an address of a communication counterpart; a communication unit capable of wirelessly connecting to a network; a controller which acquires measurement data from the weight sensor and sends, via the communication unit, the measurement data to a server an address of which has been stored in the memory; and a battery compartment which houses a battery for supplying power to the weight sensor, the memory, the communication unit, and the controller.

In this aspect, the communication unit can wirelessly communicate, and the battery in the battery compartment supplies power to the components of the weight measuring device. Thus, the weight measuring device can be placed and used in a closed space into which a communication cable or a power supply cable cannot be routed. Further, since the housing is in the shape of a flat panel, the weight measuring device can measure the weight of any product as long as the product can be placed on the flat panel-shaped housing. Therefore, the weight measuring device can be provided with remarkable general-purpose properties because the installation site and the type of products to be measured do not matter.

A seventh aspect of the present disclosure is an embodiment of the sixth aspect. In the seventh aspect, the memory stores a set value of a measurement frequency, and the controller acquires the measurement data from the weight sensor and sends the measurement data to the server at the measurement frequency stored in the memory.

In this aspect, even if a user does not instruct the weight measuring device each time to measure the weight, the controller acquires the measurement data from the weight sensor and sends the data to the server automatically and periodically at the measurement frequency stored in the memory. Thus, the weight measuring device can be placed and used even in a space which is not easy for the user to access. It the measurement of the weight and the sending of the data are performed at a predetermined measurement frequency, power consumption can be further reduced than the case where the measurement of the weight and the sending of the data are consecutively performed. This allows the weight measuring device to be stably operated for a long time even by a battery.

An eighth aspect of the present disclosure is an embodiment of the sixth or seventh aspect. In the eighth aspect, the controller sends information about remaining power of the battery housed in the battery compartment to the server.

In this aspect, a user can easily check the remaining power of the battery via the server.

A ninth aspect of the present disclosure is an embodiment of any one of the sixth to eighth aspects. In the ninth aspect, the weight measuring device further includes a measurement button and a lamp, wherein the controller acquires the measurement data from the weight sensor and sends the measurement data to the server when the measurement button is pressed, if the controller has succeeded both of the acquisition of the measurement data from the weight sensor and the sending of the measurement data to the server, the controller lights the lamp in a first mode, and if the controller has failed one or both of the acquisition of the measurement data and the sending of the measurement data to the server, the controller lights the lamp in a second mode different from the first mode.

In this aspect, the weight of the product can be measured at any given time once the user presses the measurement button. The user can tell whether the data has been successfully acquired and sent to the server or not by checking how the lamp is lit. In addition, if the lamp is not lit even if the measurement button is pressed, the user can be aware that the battery has gone dead.

A tenth aspect of the present disclosure is directed to a stock control system, including: the weight measuring device of any one of the first to ninth aspects; and a server, wherein the server includes: a correspondence memory which stores, in the memory, a correspondence between a plurality of weight measuring devices and a product placed on each of the weight measuring devices; a remaining quantity calculator which calculates a remaining quantity of each of the products based on weight data sent from the weight measuring device respectively associated with the products; and an alert generator which calculates a consumption rate of each product based on a history of the remaining quantity of the product, and determines when to generate an alert based on the calculated consumption rate of each product.

In this aspect, even if multiple products are stored in different places, the remaining quantity calculator refers to the correspondence stored in the memory to calculate the remaining quantity of each product based on the weight data sent from the weight measuring device associated with the product. Then, the alert generator calculates the consumption rate of each product based on a history of the remaining quantity of each product, and determines when to generate an alert based on the calculated consumption rate of each product. Thus, stock control of the products stored in different places can be efficiently performed. Further, what is at least required for the weight measuring device is the function of measuring the weight of the product placed thereon and sending the weight data to the server. This can simplify the configuration of the weight measuring device, and can reduce the cost for introducing the weight measuring device.

An eleventh aspect of the present disclosure is an embodiment of the tenth aspect. In the eleventh aspect, the alert generator includes a proper stock quantity calculator which calculates a proper stock quantity of each product based on the consumption rate of the product, and a remaining quantity alert generator which compares the remaining quantity of each product with its proper stock quantity, and generates, if the remaining quantity of the product is smaller than its proper stock quantity, a remaining quantity alert about the product.

A twelfth aspect of the present disclosure is an embodiment of the tenth or eleventh aspect. In the twelfth aspect, the alert generator includes an anomaly detection alert generator which compares the consumption rate of each product with an anomaly detection alert threshold for the product, and generates, if the consumption rate of the product is greater than the anomaly detection alert threshold, an anomaly detection alert about the product.

A thirteenth aspect of the present disclosure is an embodiment of any one of the tenth to eleventh aspects. In the thirteenth aspect, the alert generator includes an expiration alert generator which compares the consumption rate of each product with an expiration alert threshold for the product, and generates, if the consumption rate of the product is less than the expiration alert threshold, an expiration alert about the product.

A fourteenth aspect of the present disclosure is an embodiment of the tenth aspect. In the fourteenth aspect, the server further includes: an order request receiving unit which receives an order request for each product sent from a terminal device of a stock keeper in charge of the products; and a product ordering unit which places an order for the product to a supplier of the product stored in the memory when the order request receiving unit receives the order request for the product.

In this aspect, the product is automatically ordered in accordance with the order request from the stock keeper in charge of the product. This can greatly save the order-related labor of the stock keeper.

A fifteenth aspect of the present disclosure is an embodiment of the fourteenth aspect. In the fifteenth aspect, when the order request receiving unit receives the order request for the product, the product ordering unit determines whether a remaining quantity alert has been generated about a different product of the same type as the requested product, and if the remaining quantity alert has been generated about the different product of the same type as the requested product, the product ordering unit collectively places an order of the requested product, and an order of the different product about which the remaining quantity alert has been generated, to the supplier.

In this aspect, the product ordering unit collectively places the orders of the products of the same type, and the cost can be reduced by volume discount.

A sixteenth aspect of the present disclosure is an embodiment of the fourteenth aspect. In the sixteenth aspect, when the order request receiving unit receives the order request for the product, the product ordering unit determines whether a remaining quantity alert has been generated about a different product of which a supplier is identical to that of the requested product, and if the remaining quantity alert has been generated about the different product of which the supplier is identical to that of the requested product, the product ordering unit collectively places an order for the requested product, and an order for the different product about which the remaining quantity alert has been generated, to the supplier.

In this aspect, the product ordering unit collectively places the orders of the products from the same supplier, and the cost can be reduced by volume discount.

A seventeenth aspect of the present disclosure is an embodiment of any one of the tenth to sixteenth aspects. In the seventeenth aspect, the stock control system further includes: a display controller which shows the remaining quantity of each product together with its location information on a display.

An eighteenth aspect of the present disclosure is an embodiment of the seventeenth aspect. In the eighteenth aspect, the display controller shows a layout plan illustrating locations of the products on the display, and shows the remaining quantities of the products at the locations of the products on the layout plan based on the location information of each product.

In this aspect, the remaining quantities of the products are shown at the locations of the products on the layout plan. This allows the stock keeper to intuitionally check the location of the product which needs to be replenished.

A nineteenth aspect of the present disclosure is an embodiment of the seventeenth aspect. In the nineteenth aspect, the display controller shows, on the display, the products classified by area based on the location information of each product, and the remaining quantities of the products sorted by area.

This allows the stock keeper to collectively check the remaining quantities of the products by area, which can optimize a sales route or a replenishment route.

A twentieth aspect of the present disclosure is an embodiment of any one of the seventeenth to nineteenth aspects. In the twentieth aspect, the display controller highlights the remaining quantity of the product about which the remaining quantity alert generator has generated the remaining quantity alert.

In this aspect, the stock keeper who checks the remaining quantity of each product can easily recognize the product about which the remaining quantity alert has been generated, and the stock control can be more efficient.

A twenty-first aspect of the present disclosure is directed to a stock control system including: the weight measuring device of any one of the first to ninth aspects; and a server, wherein the server includes: a correspondence memory which stores, in the memory, a correspondence between a plurality of weight measuring devices and a product placed on each of the weight measuring devices; a remaining quantity calculator which calculates a remaining quantity of each of the products based on weight data sent from the weight measuring device respectively associated with the products; and a remaining quantity breakdown memory which stores the remaining quantity of each product together with a breakdown thereof by replenish day, and compares the remaining quantity of each product calculated by the remaining quantity calculator with the remaining quantity thereof stored in the memory, if the remaining quantity of the product calculated by the remaining quantity calculator is greater than the remaining quantity thereof stored in the memory, the remaining quantity breakdown memory adding a difference between the compared remaining quantities to the remaining quantity stored in the memory together with a date of a replenishment day, and if the remaining quantity of the product calculated by the remaining quantity calculator is less than the remaining quantity thereof stored in the memory, the remaining quantity breakdown memory reducing the remaining quantity of the product on an older date in the breakdown stored in the memory only by a difference between the compared remaining quantities; a maximum stock day calculator which calculates maximum stock days of each product based on the oldest date in the breakdown of the remaining quantity of the product stored in the memory; an upper limit calculator which calculates an upper limit value of proper stock days of each product based on a history of the maximum stock days of the product; and a dead stock alert generator which compares the maximum stock days of each product with the upper limit value of the proper stock days of the product, and generates a dead stock alert about the product if the maximum stock days of the product has exceeded the upper limit value of the proper stock days of the product.

In this aspect, even if multiple products are stored in different places, the remaining quantity calculator refers to the correspondence stored in the memory to calculate the remaining quantity of each product based on the weight data sent from the weight measuring device associated with the product. Then, the maximum stock day calculator calculates the maximum stock days of each product based on the calculated remaining quantity of each product, and the upper limit calculator calculates the upper limit value of the proper stock days based on the history of the maximum stock days of each product. If the maximum stock days of the product have exceeded the upper limit value of the proper stock days of the product, the dead stock alert generator generates a dead stock alert about the product. Thus, stock control of the products stored in different places can be efficiently performed. Further, what is at least required for the weight measuring device is the function of measuring the weight of the product placed thereon and sending the weight data to the remaining quantity calculator. This can reduce the cost for introducing the weight measuring device.

A twenty-second aspect of the present disclosure is an embodiment of the twenty-first aspect. In the twenty-second aspect, the stock control system further includes: a display controller which shows the maximum stock days of each product together with its location information on a display.

A twenty-third aspect of the present disclosure is an embodiment of the twenty-second aspect. In the twenty-third aspect, the display controller shows a layout plan illustrating locations of the products on the display, and shows the remaining quantities of the products at the locations of the products on the layout plan based on the location information of each product.

In this aspect, the maximum stock days of the products are shown at the locations of the products on the layout plan. This allows the stock keeper to intuitionally check the location of the product which may have turned to be a dead stock.

A twenty-fourth aspect of the present disclosure is an embodiment of the twenty-second aspect. In the twenty-fourth aspect, the display controller shows, on the display, the products classified by area based on the location information of each product, and the maximum stock days of the products sorted by area.

This allows the stock keeper to collectively check the maximum stock days of the products by area, which can optimize a sales route or a dead stock replacement route.

A twenty-fifth aspect of the present disclosure is an embodiment of any one of the twenty-second to twenty-fourth aspects. In the twenty-fifth aspect, the display controller highlights the maximum stock days of the product about which the dead stock alert generator has generated the dead stock alert.

In this aspect, the stock keeper who checks the maximum stock days of each product can easily recognize the product about which the dead stock alert has been generated, and the stock control can be more efficient.

A twenty-sixth aspect of the present disclosure is directed to a server including: a correspondence memory which stores, in the memory, a correspondence between a plurality of weight measuring devices and a product placed on each of the weight measuring devices; a remaining quantity calculator which calculates a remaining quantity of each product based on weight data sent from the weight measuring device associated with the product; and an alert generator which calculates a consumption rate of each product based on a history of the retraining quantity of the product, and determines when to generate an alert based on the calculated consumption rate of each product.

A twenty-seventh aspect of the present disclosure is directed to a server including: a correspondence memory which stores, in a memory, a correspondence between a plurality of weight measuring devices and a product placed on each of the weight measuring devices; a remaining quantity calculator which calculates a remaining quantity of each product based on weight data sent from the weight measuring device associated with the product; and a remaining quantity breakdown memory which stores the remaining quantity of each product together with a breakdown thereof by replenish day, and compares the remaining quantity of each product calculated by a remaining quantity calculator with the remaining quantity thereof stored in the memory, if the remaining quantity of the product calculated by the remaining quantity calculator is greater than the remaining quantity thereof stored in the memory, the remaining quantity breakdown memory adding a difference between the compared remaining quantities to the remaining quantity stored in the memory together with a date of a replenishment day, and if the remaining quantity of the product calculated by the remaining quantity calculator is less than the remaining quantity thereof stored in the memory, the remaining quantity breakdown memory reducing the remaining quantity of the product on an older date in the breakdown stored in the memory only by a difference between the compared remaining quantities; a maximum stock day calculator which calculates maximum stock days of each product based on the oldest date in the breakdown of the remaining quantity of the product stored in the memory; an upper limit calculator which calculates an upper limit value of proper stock days of each product based on a history of the maximum stock days of the product; and a dead stock alert generator which compares the maximum stock days of each product with the upper limit value of the proper stock days of the product, and generates a dead stock alert about the product if the maximum stock days of the product has exceeded the upper limit value of the proper stock days of the product.

A twenty-eighth aspect of the present disclosure is directed to a stock control method including: storing in a memory a correspondence between a plurality of weight measuring devices and a product placed on each of the weight measuring devices; calculating a remaining quantity of each product based on weight data sent from the weight measuring device associated with the product; and calculating a consumption rate of each product based on a history of the remaining quantity of the product, thereby determining when to generate an alert based on the calculated consumption rate of each product.

A twenty-ninth aspect of the present disclosure is directed to a stock control method including: storing in a memory a correspondence between a plurality of weight measuring devices and a product placed on each of the weight measuring devices; calculating a remaining quantity of each product based on weight data sent from the weight measuring device associated with the product; and storing, in the memory, the remaining quantity of each product together with a breakdown thereof by replenishment day, and comparing the remaining quantity of each product calculated by a remaining quantity calculator with the remaining quantity thereof stored in the memory, wherein if the remaining quantity of the product calculated by the remaining quantity calculator is greater than the renaming quantity thereof stored in the memory, a difference between the compared remaining quantities is added to the remaining quantity of the product stored in the memory together with a date of the replenishment day, and if the remaining quantity of the product calculated by the remaining quantity calculator is less than the remaining quantity thereof stored in the memory, the remaining quantity of the product on an older date in the breakdown stored in the memory is reduced only by a difference between the compared remaining quantities; calculating maximum stock days of each product based on the oldest date in the breakdown of the remaining quantity of the product stored in the memory; calculating an upper limit value of proper stock days of each product based on a history of the maximum stock days of the product; and comparing the maximum stock days of each product with the upper limit value of the proper stock days of the product, and generating a dead stock alert about the product if the maximum stock days of the product has exceeded the upper limit value of the proper stock days of the product.

A thirtieth aspect of the present disclosure is directed to a stock control program which causes a computer to execute processes of: storing in a memory a correspondence between a plurality of weight measuring devices and a product placed on each of the weight measuring devices; calculating a remaining quantity of each product based on weight data sent from the weight measuring device associated with the product; and calculating a consumption rate of each product based on a history of the remaining quantity of the product, thereby determining when to generate an alert based on the calculated consumption rate of each product.

A thirty-first aspect of the present disclosure is directed to a stock control program which causes a computer to execute processes of: storing in a memory a correspondence between a plurality of weight measuring devices and a product placed on each of the weight measuring devices; calculating a remaining quantity of each product based on weight data sent from the weight measuring device associated with the product; and storing, in the memory, the remaining quantity of each product together with a breakdown thereof by replenishment day, and comparing the remaining quantity of each product calculated by a remaining quantity calculator with the remaining quantity thereof stored in the memory, wherein if the remaining quantity of the product calculated by the remaining quantity calculator is greater than the remaining quantity thereof stored in the memory, a difference between the compared remaining quantities is added to the remaining quantity of the product stored in the memory together with a date of the replenishment day, and if the remaining quantity of the product calculated by the remaining quantity calculator is less than the remaining quantity thereof stored in the memory, the remaining quantity of the product on an older date in the breakdown stored in the memory is reduced only by a difference between the compared remaining quantities; calculating maximum stock days of each product based on the oldest date in the breakdown of the remaining quantity of the product stored in the memory; calculating an upper limit value of proper stock days of each product based on a history of the maximum stock days of the product; and comparing the maximum stock days of each product with the upper limit value of the proper stock days of the product, and generating a dead stock alert about the product if the maximum stock days of the product has exceeded the upper limit value of the proper stock days of the product.

### Advantages of the Disclosure

According to the present disclosure, a general-purpose weight measuring device usable for stock control can be provided.

### EMBODIMENTS

Embodiments will be described below in detail with reference to the accompanying drawings. The following description of the embodiments is merely an example of implementation of the present disclosure, and does not limit the present disclosure to the specific configuration to be described below. To implement the present disclosure, specific configuration in accordance with the embodiments may be applied as appropriate.

### Configuration of Stock Control System

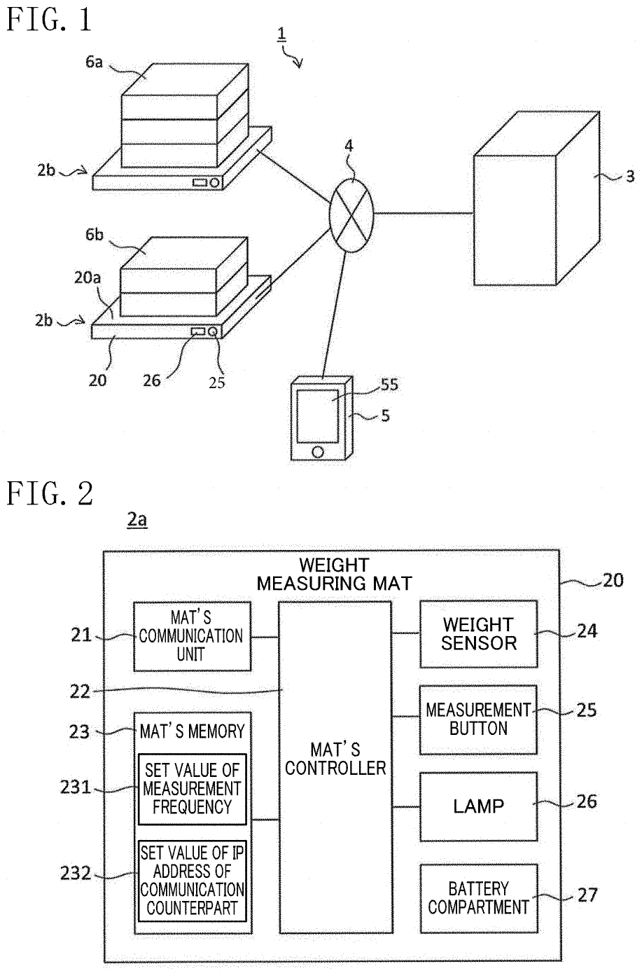

FIG. 1 illustrates an example of a configuration of a stock control system according to an embodiment.

As shown in FIG. 1, a stock control system 1 includes weight measuring devices 2a, 2b, a server 3, and a terminal device 5. The weight measuring devices 2a, 2b, the server 3, and the terminal device 5 are connected together via a network 4 such as the Internet to be able to communicate with each other. The network 4 may be wired or wireless, and the type and form thereof are not limited. At least some of the weight measuring devices 2a, 2b, the server 3, and the terminal device 5 are implemented by a computer.

The terminal device 5 is operated by a stock keeper of products 6a, 6b, and may be, for example, an electronic instrument such as a mobile terminal including smartphones and tablets, a notebook computer, or a desktop computer.

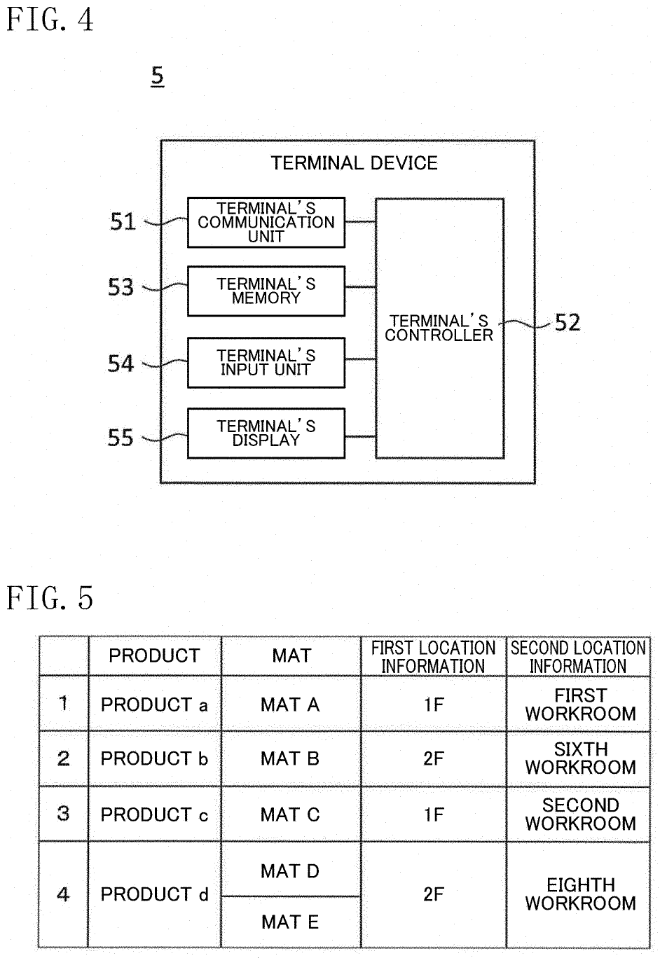

FIG. 4 illustrates an example of a configuration of the terminal device 5. As shown in FIG. 4, the terminal device 5 includes a terminal's communication unit 51, a terminal's controller 52, a terminal's memory 53, a terminal's input unit 54, and a terminal's display 55 (corresponding to a “display” recited in claims). These components are connected together via a bus to be able to communicate with each other.

The terminal's communication unit 51 is a communication interface between the terminal device 5 and the network 4. The terminal's communication unit 51 performs transmission and reception of information between the terminal device 5 and the server 3 via the network 4.

The terminal's controller 52 is a control means which performs various types of processing of the terminal device 5. The terminal's controller 52 may be implemented by a predetermined program executed by a processor in the terminal device 5, or may be a hardware.

The terminal's memory 53 is, for example, data storage such as a built-in memory, or an external memory (e.g., SD memory card). The terminal's memory 53 stores various types of data handled by the terminal's controller 52.

The terminal's input unit 54 is an interface through which a user enters information to the terminal device 5. Examples thereof may include a touch panel or microphone of a mobile terminal, and a touch pad, keyboard, or mouse of a notebook computer.

The terminal's display 55 is an interface which shows various types of information from the terminal device 5 to the user. Examples thereof may include a graphic display means such as a liquid crystal display. Specifically, the terminal's display 55 may show, for example, a graphical user interface (GUI) which can be operated by a user.

A configuration of the weight measuring device 2a, 2b will be described below.

As shown in FIG. 1, each of the weight measuring devices 2a, 2b is a general-purpose weight measuring device, and can be used for stock control. In this specification, the term “general-purpose” means that there is no limitation on the product to be measured, and the weight measuring device can measure the weight of any product as long as the product can be placed thereon.

In this embodiment, the weight measuring device 2a, 2b is configured as a weight measuring mat. In this specification, the “weight measuring mat” is a weight measuring device which can be laid under a target to be measured, like a mat, and has a plate-shaped table on which the target is placed. In the following description, the weight measuring devices 2a, 2b may sometimes be referred to as the weight measuring mats 2a, 2b.

In an example shown in FIG. 1, each weight measuring mat 2a, 2b is in the shape of a flat panel and can measure the weight of any product that can be placed on the flat panel-shaped weight measuring mat. In this specification, the shape of a “flat panel” means a shape which can keep the target placed thereon in a horizontal position for the measurement. The “flat panel” may have a smooth top, or an anti-skid top with minute asperities, as long as the target placed thereon can be kept in the horizontal position for the measurement. Further, in the illustrated example, the weight measuring mats 2a, 2b are rectangular when viewed in plan. However, this is not limiting, and the mats 2a and 2b may be in the shape of a circle, a triangle, or a polygon with five or more sides when viewed in plan.

In this embodiment, each weight measuring mat 2a, 2b has a planar shape in accordance with a particular standard. Specifically, for example, the planar shape of the weight measuring mat 2a, 2b may be a size of A3 (40 cm×30 cm) or A4 (30 cm×20 cm) in accordance with JIS P0138, a standard of writing paper and certain classes of primed matter. Having the standardized planar shape, a plurality of weight measuring mats 2a, 2b can be easily placed in combination in the planar direction.

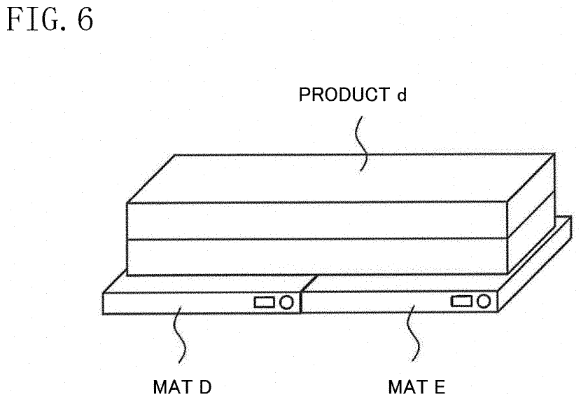

As shown in FIG. 6, multiple (two in the illustrated example) weight measuring mats 2a, 2b can be combined in the planar direction. Combining the weight measuring mats 2a, 2b in the planar direction makes it possible to measure the weight of the product, even if it is large in size.

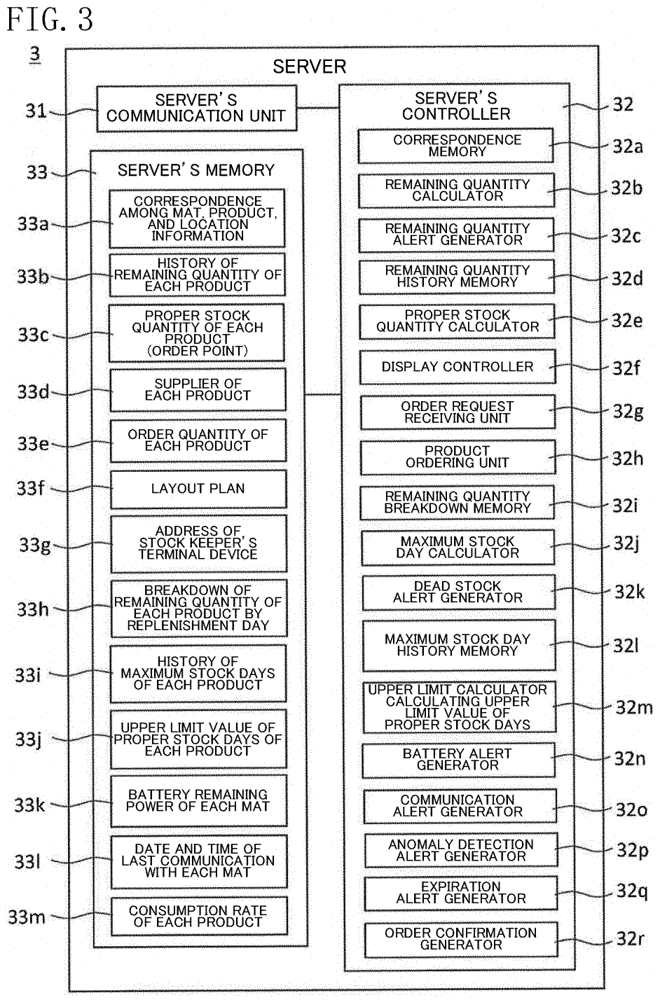

FIG. 2 illustrates an example of a configuration of the weight measuring mats 2a, 2b. The weight measuring mats 2a, 2b have the same configuration, and thus, the following description will be focused on the configuration of the weight measuring mat 2a.

As shown in FIG. 2, the weight measuring mat 2a includes a housing 20, a mat's communication unit 21, a mat's controller 22, a mat's memory 23, a weight sensor 24, a measurement button 25, a lamp 26, and a battery compartment 27. The housing 20 is in the shape of a flat panel, and houses the components 21 to 27 therein.

The mat's communication unit 21 is a communication interface between the weight measuring mat 2a and the network 4. In this embodiment, the mat's communication unit 21 can be wirelessly connected to the network 4, and performs transmission and reception of information between the weight measuring mat 2a and the server 3. The wireless communications standard may be, for example, Wi-Fi, LTE/5G, Cat. M1, or NB-IoT.

The mat's memory 23 is for example, data storage such as a memory built in a microcomputer, or an external memory (e.g., SD memory card). The mat's memory 23 stores various types of data handled by the mat's controller 22. For example, the mat's memory 23 stores a set value 231 of a measurement frequency, and a set value 232 of an IP address of a communication counterpart. The set value 231 of the measurement frequency and the set value 232 of the IP address of the communication counterpart can be determined by the terminal device 5 of the stock keeper via the network 4.

The mat's controller 22 is a control means which performs various types of processing of the weight measuring mat 2a. The mat's controller 22 may be implemented by a predetermined program executed by a processor of the microcomputer in the weight measuring mat 2a, or may be a hardware.

The mat's controller 22 acquires measurement data of the product's weight from the weight sensor 24 at a measurement frequency determined by the set value 231 of the measurement frequency (e.g., once every hour), and sends the acquired measurement data to the server 3 specified by the set value 232 of the IP address of the communication counterpart together with ID information unique to each mat. The mat's controller 22 may check, at a predetermined frequency (e.g., once every day), the remaining power of the battery in the battery compartment 27 based on a voltage, and send the information of the remaining battery power to the server 3 together with the ID information. The mat's controller 22 may be connected to the server 3 at a predetermined frequency (e.g., once every day) to correct a clock in the weight measuring mat 2a based on time information of a clock in the server 3, and check the latest firmware on the server 3. When the operation described above is not performed, the mat's controller 22 may sleep with current consumption lowered, for example, to 500 μAh or less. This allows the mat to stably operate with no trouble for more than a year even if the battery in the battery compartment 27 is used as a power supply.

The battery compartment 27 may house a battery, such as a dry cell or a storage cell which supplies power to the components 21 to 26. In this embodiment, the weight measuring mat 2a has no power switch, and is activated when the battery is inserted in the battery compartment 27. This can eliminate the possibility that a user forgets about turning the power switch on. Further, since only the measurement button 25 serves as the operation interface of the weight measuring mat 2a, such a simple configuration makes the mat user-friendly.

The weight sensor 24 is for example, a load cell. In this embodiment, the weight sensor 24 is provided for a worktop 20a (see FIG. 1 ) of the housing 20 of the weight measuring mat 2a which is rectangular when viewed in plan (or in the shape of a substantially rectangle with rounded corners). The weight sensor 24 measures the weight of a product placed on the worktop 20a.

The measurement button 25 is provided at one of the corners of the housing 20 of the weight measuring mat 2a. When the user presses the measurement button 25, the mat's controller 22 acquires measurement data of the product's weight from the weight sensor 24, and sends the acquired measurement data to the server 3.

The lamp 26 is provided at the corner of the housing 20 of the weight measuring mat 2a to be adjacent to the measurement button 25. In this embodiment, if the measurement data is acquired and sent successfully when the measurement button 25 is pressed by the user, the lamp 26 is lit in a first mode (e.g., in green). If one or both of the acquirement and sending of the measurement data is failed, the lamp 26 is lit in a second mode different from the first mode (e.g., in red). If the battery in the battery compartment 27 goes dead, the lamp 26 is not lit even if the measurement button 25 is pressed. This allows the user to easily check whether the power of the battery in the battery compartment 27 is left or not by seeing whether the lamp 26 is lit or not upon pressing of the measurement button 25.

A configuration of the server 3 will be described below. FIG. 3 illustrates an example of a configuration of the server 3.

As shown in FIG. 3, the server 3 is, for example, a cloud server, and includes a server's communication unit 31, a server's controller 32, and a server's memory 33 (corresponding to a “memory” recited in claims). These components are connected together via a bus or a network to be able to communicate with each other.

The server's communication unit 31 is a communication interface between the server 3 and the network 4. The server's communication unit 31 performs transmission and reception of information among the weight measuring mats 2a, 2b, the terminal device 5, and the server 3 via the network 4.

The server's memory 33 is, for example, fixed data storage such as a hard disk. The server's memory 33 stores various types of data handled by the server's controller 32. For example, the server's memory 33 stores a correspondence 33a among the weight measuring mats 2a, 2b (ID information of the weight measuring mats 2a, 2b), products 6a, 6b placed on the weight measuring mats 2a, 2b, and location information of the products 6a, 6b. The location information of the products 6a, 6b may include location information of a plurality of stages different in the scale.

FIG. 5 illustrates an example of the correspondence 33a among the weight measuring mats 2a, 2b, the products 6a, 6b, and the location information. In the example shown in FIG. 5, a weight measuring mat A, a product a placed on the weight measuring mat A, and a storage location of the product a as the location information, i.e., a first workroom (second location information) on the first floor (1F) (first location information), are stored in association with each other. A weight measuring mat B, a product b placed on the weight measuring mat B, and a storage location of the product b as the location information, i.e., a sixth workroom (second location information) on the second flow (2F) (first location information), are stored in association with each other. A weight measuring mat C, a product c placed on the weight measuring mat B, and a storage location of the product c as the location information, i.e., a second workroom (second location information) on the first floor (1F) (first location information), are stored in association with each other. Further, weight measuring mats D and E, a product d placed across both of the weight measuring mats D and E (see FIG. 6), and a storage location of the product d as the location information, i.e., an eighth workroom (second location information) on the second floor (2F) (first location information), are stored in association with each other.

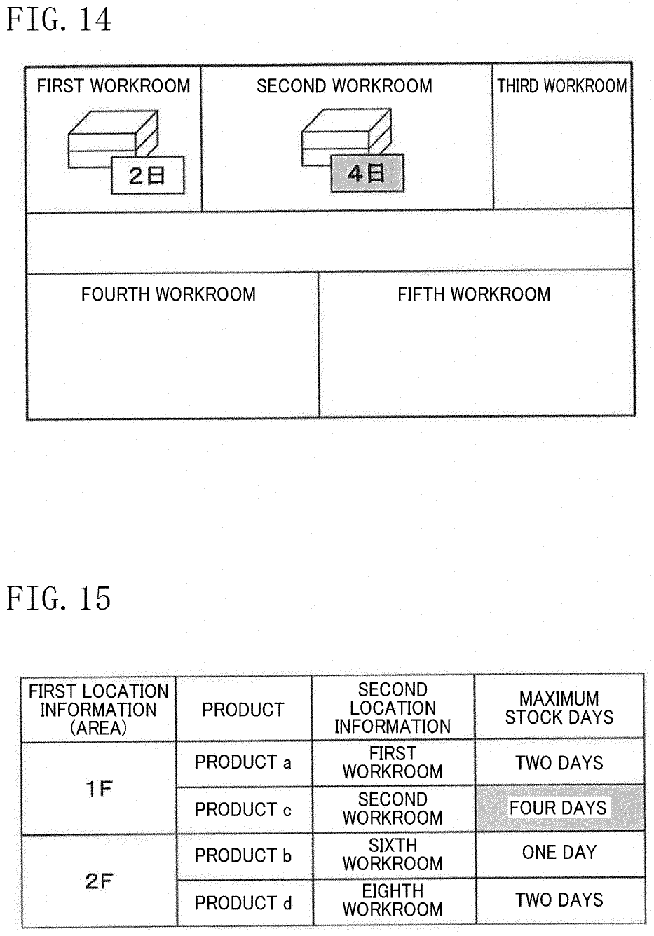

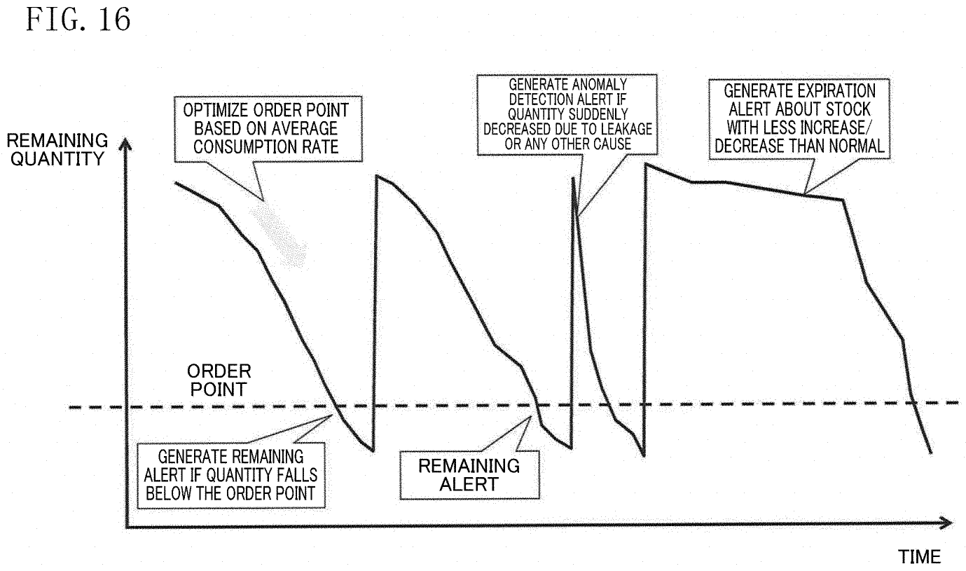

As shown in FIG. 3, the server's memory 33 further stores: a history 33b of the remaining quantity of each product 6a, 6b (see FIG. 16); a proper stock quantity 33c of each product 6a, 6b; a supplier 33d of each product 6a, 6b; an order quantity 33e of each product 6a, 6b; a layout plan 33f indicating the location of each product 6a, 6b (see FIGS. 9 and 14); and an address 33g of the terminal device 5 of the stock keeper in charge of each product 6a, 6b.

In addition, the server's memory 33 stores: a breakdown 33h of the remaining quantity of each product 6a, 6b by replenishment day; a history 33i of maximum stock days of each product 6a, 6b; and an upper limit value 33j of proper stock days of each product 6a, 6b. The server's memory 33 also stores: remaining battery power 33k of each weight measuring mat 2a, 2b; date and time 33l of the last communication with each weight measuring mat 2a, 2b; and an average consumption rate 33m of each product 6a, 6b.

As shown in FIG. 3, the server's controller 32 includes a correspondence memory 32a, a remaining quantity calculator 32b, a remaining quantity history memory 32d, an alert generator, a display controller 32f, an order request receiving unit 32g, a product ordering unit 32h. a remaining quantity breakdown memory 32i, a maximum stock day calculator 32j, a dead stock alert generator 32k, a maximum stock day history memory 32l, an upper limit calculator 32m calculating an upper limit value of proper stock days (will be hereinafter simply referred to as an “upper limit calculator”), and an order confirmation generator 33r. These components may be implemented by a predetermined program executed by a processor in the server 3, or may be a hardware.

The correspondence memory 32a stores, in the server's memory 33, a correspondence between a plurality of weight measuring mats 2a, 2b and the products 6a, 6b placed on the weight measuring mats 2a, 2b. The correspondence memory 32a may store, in the server's memory 33, a correspondence 33a among the plurality of weight measuring mats 2a, 2b, the products placed on the weight measuring mats 2a, 2b, and the location information of the products 6a, 6b.

The remaining quantity calculator 32b calculates the remaining quantity (e.g., in percentage or number) of each product 6a, 6b based on the weight data sent from the weight measuring mat 2a, 2b corresponding to the products 6a, 6b. In the example shown in FIG. 5, the remaining quantity calculator 32b calculates: the remaining quantity of the product a based on the weight data sent from the weight measuring mat A; the remaining quantity of the product b based on the weight data sent from the weight measuring mat B; the remaining quantity of the product c based on the weight data sent from the weight measuring mat C; and the remaining quantity of the product d based on the sum of the weight data sent from the weight measuring mat D and the weight data sent from the weight measuring mat E.

The remaining quantity history memory 32d stores (accumulates), in the server's memory 33, the remaining quantity of each product 6a, 6b calculated by the remaining quantity calculator 32b together with the information about the date and time of the measurement, thereby forming the history 33b of the remaining quantity of each product 6a, 6b (see FIG. 16).

The alert generator calculates the average consumption rale 33m of each product 6a, 6b based on the history 33b of the remaining quantity of the product, and determines when to generate an alert bused on the calculated average consumption rate 33m of each product. The alert generator may store, in the memory 33, the calculated average consumption rate 33m of each product. The alert generator includes a proper stock quantity calculator 32e, a remaining quantity alert generator 32c, a battery alert generator 32n, a communication alert generator 32o, an anomaly detection alert generator 32p, and an expiration alert generator 32q.

The proper stock quantity calculator 32e calculates, based on the average consumption rate 33m of each product 6a, 6b, a proper stock quantity 33c (will be sometimes referred to as an “order point”) of each product 6a, 6b. Specifically, for example, the proper stock quantity calculator 32e calculates an “average quantity used per day (kg),” i.e., the average consumption rate 33m, and a “standard deviation of the quantity used per day” from the history 33b of the remaining quantity of each product 6a, 6b. The proper stock quantity calculator 32e further calculates a “safe stock quantity” from a formula: “safe stock quantity (kg)”=“safety coefficient”×“standard deviation of quantity used per day”×√ (“order lead time (day)”+“order interval (day)”). In this context, the “safety coefficient” is a value obtained from a table of normal distribution, and is 2.33 if an acceptable stockout rate is 1%, for example. The safety coefficient is 1.65 if the acceptable stockout rate is 5%, and 1.29 if the acceptable stockout rate is 10%. Then, the proper stock quantity calculator 32e calculates a “proper stock quantity (kg)” from a formula: “proper stock quantity (kg)”=“average quantity used per day (kg)”×“maximum procurement lead time (day)”+“safe stock quantity (kg).” The calculated proper stock quantity 33c is stored in the server's memory 33.

The remaining quantity alert generator 32c compares the remaining quantity of each product 6a, 6b calculated by the remaining quantity calculator 32b with the proper stock quantity 33c of the product stored in the server's memory 33. It the remaining quantity of the product 6a, 6b is smaller than the proper stock quantity 33c (order point) of the product, the remaining quantity alert generator 32c generates a remaining quantity alert about the product 6a, 6b (see FIG. 16).

The remaining quantity alert generator 32c may refer to the address 33g of the terminal device 5 of the stock keeper in charge of the product 6a, 6b stored in the server's memory 33, and send the remaining quantity alert about the product 6a, 6b to the terminal device 5 of the stock keeper in charge of the product 6a, 6b by e-mail or instant message.

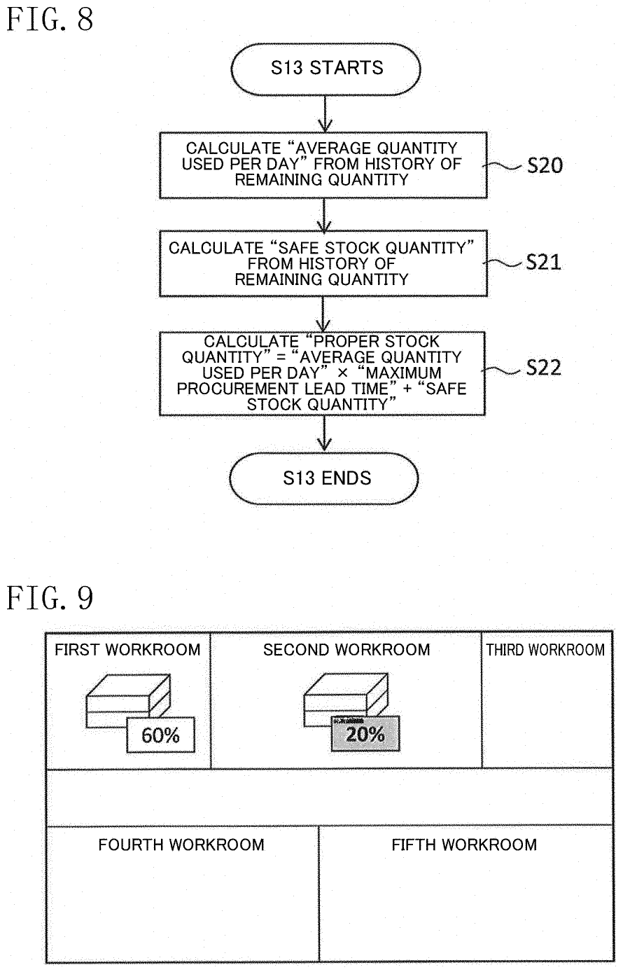

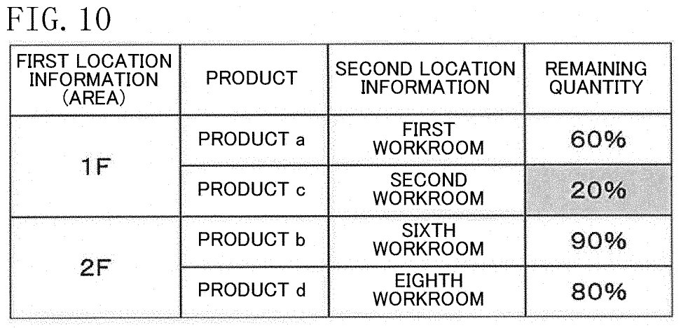

The display controller 32f sends the remaining quantity of each product 6a, 6b calculated by the remaining quantity calculator 32b to the terminal device 5 of the stock keeper, and shows the remaining quantity on the terminal's display 55 (see FIGS. 9 and 10). The display controller 32f may highlight the remaining quantity of the product 6a, 6b about which the remaining quantity alert generator 32c has generated the remaining quantity alert. The “highlighting” means that a target value is emphasized to be more easily recognized than the other values. For example, the target value may be displayed in a color different from other values (preferably, in bright, eye-catching color such as red), may be displayed in boldface type or reverse video, or may be kept blinking. Alternatively, the background of the target value may be displayed in a color different from other values. In the example shown in FIGS. 8 and 9, the display controller 32f highlights the remaining quantity of the product c “20%” by displaying its background in a color different from the backgrounds of the remaining quantities of the other products.

Alternatively, the display controller 32f may display, on the terminal's display 55, the remaining quantities of the products 6a, 6b calculated by the remaining quantity calculator 32b together with the location information of the products 6a, 6b stored in the server's memory 33. For example, as shown in FIG. 9, the display controller 32f may display a layout plan 33f illustrating the locations of the products 6a, 6b on the terminal's display 55, together with the remaining quantities of the products 6a, 6b at the locations of the products 6a, 6b on the layout plan based on the location information of the products 6a, 6b stored in the server's memory 33. Alternatively, as shown in FIG. 10, the display controller 32f may show, on the terminal's display 55, the products 6a, 6b classified by area (floor number of a facility in the illustrated example) based on the location information (e.g., the first location information) of each product 6a, 6b stored in the server's memory 33, together with the remaining quantities of the products 6a, 6b sorted by area.

The order request receiving unit 32g receives an order request for the product 6a, 6b sent from the terminal device 5 of the stock keeper in charge of the products 6a, 6b.

When the order request receiving unit 32g receives the order request for each product 6a, 6b, the product ordering unit 32h places an order for the product 6a, 6b by an order quantity 33e stored in the server's memory 33 to the supplier 33d of the product stored in the server's memory 33.

As an example, when the order request receiving unit 32g receives the order request for a certain product, the product ordering unit 32h determines whether the remaining quantity alert has been generated about a different product of the same type as the requested product. If the remaining quantity alert has been generated about the different product of the same type as the requested product, the product ordering unit 32h may collectively place an order for the requested product, and an order for the different product about which the remaining quantity alert has been generated, to the supplier 33d of the requested product.

As another example, when the order request receiving unit 32g receives the order request for a certain product, the product ordering unit 32h determines whether the remaining quantity alert has been generated about a different product of which the supplier is identical to that of the requested product. If the remaining quantity alert has been generated about the different product of which the supplier is identical to that of the requested product, the product ordering unit 32h may collectively place an order for the requested product, and an order for the different product about which the remaining quantity alert has been generated, to the supplier 33d of the requested product.

If the process of ordering the requested product 6a, 6b to the supplier 33d has been succeeded, the order confirmation generator 33r generates an order confirmation of the order for the product 6a, 6b, and sends the order confirmation to the terminal device 5 of the stock keeper in charge of the product 6a, 6b by e-mail or instant message.

The anomaly detection alert generator 32p compares the average consumption rate 33m of each product 6a, 6b with a predetermined anomaly detection alert threshold. If the average consumption rate 33m is greater than the anomaly detection alert threshold, the anomaly detection alert generator 32p generates an anomaly detection alert (see FIG. 16). Thus, if the remaining quantity of the product 6a, 6b suddenly decreases due to leakage or any other cause, the stock keeper in charge of the product 6a, 6b can be quickly informed of the anomaly before the generation of the remaining quantity alert.

The expiration alert generator 32q compares the average consumption rate 33m of each product 6a, 6b with a predetermined expiration alert threshold. If the average consumption rate 33m is less than the expiration threshold, the expiration alert generator 32q generates an expiration alert (see FIG. 16). Thus, when the consumption rates of the products 6a, 6b are lower than expected, the stock keeper in charge of the products 6a, 6b can be informed of the possibility that some products have been expired. In this context, if the products 6a, 6b are food, the “expiration” may indicate that the products have reached a best-before date or an expiry date. Alternatively, if the products 6a, 6b are those making use of a chemical reaction, such as batteries and disposable heat packs, the “expiration” may indicate that the products have reached a use-by date, a recommended use-by date, or a validated date.

The battery alert generator 32n compares the remaining battery power 33k of each weight measuring mat 2a, 2b with a predetermined battery alert threshold, and generates a battery alert if the remaining battery power 33k of any of the weight measuring mats 2a, 2b is less than the battery alert threshold. Thus, the stock keeper in charge of the products 6a, 6b can be informed in advance of the possibility that the remaining battery power of any of the weight measuring mats 2a, 2b becomes insufficient.

The communication alert generator 33o compares time elapsed since the date and time 33l of the last communication with the weight measuring mat 2a, 2b with a predetermined communication alert threshold, and generates a communication alert if time elapsed since the date and time 33l of the last communication with the weight measuring mat 2a, 2b is greater than the communication alert threshold. Thus, the stock keeper in charge of the products 6a and 6b can be informed of the possibility of failure of the communication with any of the weight measuring mats 2a, 2b.

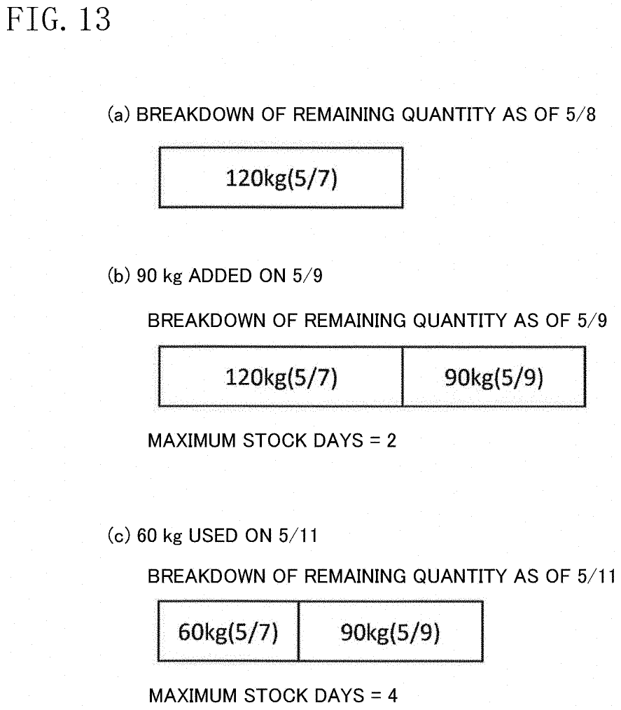

The remaining quantity breakdown memory 32i stores, in the server's memory 33, the remaining quantity of each product 6a, 6b together with a breakdown 33h thereof by replenishment day. In the example (a) shown in FIG. 13, the remaining quantity breakdown memory 32i stores, in the server's memory 33, the remaining quantity of a certain product, 120 kg, together with the date of the replenishment day, May 7th (5/7).

The remaining quantity breakdown memory 32i compares the remaining quantity A of the product 6a, 6b calculated by the remaining quantity calculator 32b with the remaining quantity B (i.e., the previous day's remaining quantity) of the product 6a, 6b stored in the server's memory 33. If the remaining quantity A of the product 6a, 6b calculated by the remaining quantity calculator 32b is greater than the remaining quantity B of the product 6a, 6b stored in the server's memory 33 (remaining quantity A>remaining quantity B), the remaining quantity breakdown memory 32i adds the difference (=remaining quantity A−remaining quantity B) to the breakdown 33h of the remaining quantity of the product 6a, 6b stored in the server's memory 33 together with the date of the replenishment day. In the example (b) shown in FIG. 13, the remaining quantity (210 kg) of the product calculated by the remaining quantity calculator 32b on May 9th (5/9) is greater than the remaining quantity (120 kg) of the product as of May 8th (5/8). Thus, the remaining quantity breakdown memory 32i adds the difference (90 kg) to the breakdown 33h of the remaining quantity of the product stored in the server's memory 33 together with the date of the replenishment day, which is May 9th (5/9).

If the remaining quantity A of the product 6a, 6b calculated by the remaining quantity calculator 32b is less than the remaining quantity B of the product 6a, 6b stored in the server's memory 33 (remaining quantity A>remaining quantity B), the remaining quantity breakdown memory 32i reduces the remaining quantity of the product 6a, 6b on the older date in the breakdown 33h stored in the server's memory 33 only by the difference (=remaining quantity B−remaining quantity A). In the example (c) shown in FIG. 13, the remaining quantity (150 kg) of the product calculated by the remaining quantity calculator 32b on May 11th (5/11) is less than the remaining quantity (210 kg) as of May 10th (5/10). Thus, the remaining quantity breakdown memory 32i preferentially reduces the remaining quantity of the product on the oldest date, i.e., May 7th (5/7), in the breakdown stored in the server's memory 33 only by the difference (60 kg).

The maximum stock day calculator 32j calculates the maximum stock days of the product 6a, 6b based on the oldest date in the breakdown of the remaining quantity of the product 6a, 6b stored in the server's memory 33. In the example (b) shown in FIG. 13, the maximum stock day calculator 32j calculates a difference between the date of the current day (5/9) and the oldest date (5/7) in the breakdown of the remaining quantity of the product stored in the server's memory 33, thereby calculating the maximum stock days to be two days. In the example (c) shown in FIG. 13, the maximum stock day calculator 32j calculates a difference between the date of the current day (5/11) and the oldest date (5/7) in the breakdown of the remaining quantity of the product stored in the server's memory 33, thereby calculating the maximum stock days to be four days.

The maximum stock day history memory 321 stores (accumulates), in the server's memory 33, the maximum stock days of each product 6a, 6b calculated by the maximum stock day calculator 32j together with the information about the date and time of the measurement, thereby forming a history 33i of the maximum stock days of each product 6a, 6b.

The upper limit calculator 32m calculates an upper limit value 33j of the proper stock days of each product 6a, 6b based on the history 33i of the maximum stock days of each product 6a, 6b. Specifically, for example, the upper limit calculator 32m calculates, from the history 33i of the maximum stock days, an “average of the maximum stock days” and a “standard deviation of the maximum stock days,” and then calculates an “upper limit value of the proper stock days” from a formula: “upper limit value of the proper stock days”=“average of the maximum stock days”+“standard deviation of the maximum stock days”×α (α is any number of 1 to 3). The upper limit value 33j of the proper stock days calculated in this manner is stored in the server's memory 33.

The dead stock alert generator 32k compares the maximum stock days of each product 6a, 6b calculated by the maximum stock day calculator 32j with the upper limit value 33j of the proper stock days of each product 6a, 6b stored in the server's memory 33. If the maximum stock days of any of the products 6a, 6b has exceeded the upper limit value 33j of the proper stock days thereof, the dead stock alert generator 32k generates a dead stock alert about the product 6a, 6b.

The dead stock alert generator 32k may refer to the address 33g of the terminal device 5 of the product 6a, 6b stored in the server's memory 33, and send the dead stock alert about the product 6a, 6b to the terminal device 5 of the stock keeper in charge of the product 6a, 6b by e-mail or instant message.

The display controller 32f described above sends the maximum stock days of each product 6a, 6b calculated by the maximum stock day calculator 32j to the terminal device 5 of the stock keeper to show the maximum stock days on the terminal's display 55 (see FIGS. 14 and 15). The display controller 32f may highlight the maximum stock days of the product 6a, 6b about which the dead stock alert generator 32k has generated the dead stock alert. In the example shown in FIGS. 14 and 15, the display controller 32f highlights the maximum stock days of the product c “four days” by displaying its background in a color different from the backgrounds of the maximum stock days of the other products.

Alternatively, the display controller 32f may show, on the terminal's display 55, the maximum stock days of each product 6a, 6b calculated by the maximum stock day calculator 32j together with the location information of the product 6a, 6b stored in the server's memory 33. For example, as shown in FIG. 14, the display controller 32f may display a layout plan 33f illustrating the locations of the products 6a, 6b on the terminal's display 55, together with the maximum stock days of the products 6a, 6b at the locations of the products 6a, 6b on the layout plan based on the location information of the products 6a, 6b stored in the server's memory 33. Alternatively, as shown in FIG. 15, the display controller 32f may show, on the terminal's display 55, the products 6a, 6b classified by area (floor number in the illustrated example) based on the location information (e.g., the first location information) of each product 6a, 6b stored in the server's memory 33, together with the maximum stock days of the products 6a, 6b sorted by area.

### Process of Generating Remaining Quantity Alert

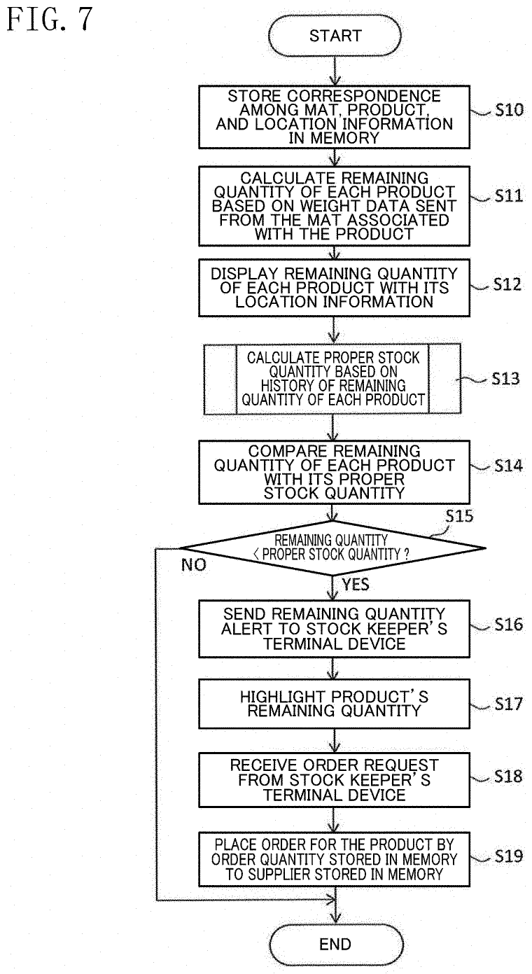

Referring to FIGS. 7 to 10, how the remaining quantity alert is generated by an information processing system 1 will be described below. FIG. 7 is a flowchart illustrating an example of how the remaining quantity alert is generated by the information processing system 1. FIG. 8 is a flowchart illustrating an example of a step of calculating a proper stock quantity. FIGS. 9 and 10 show an example of a screen displayed when the information processing system 1 generates the remaining quantity alert.

Referring to FIG. 7, if the stock keeper of the products 6a, 6b enters, via the terminal's input unit 54 of the terminal device 5, a correspondence among the plurality of weight measuring mats 2a, 2b (ID information of the weight measuring mats 2a, 2b), the products placed on the weight measuring mats 2a, 2b, and location information of the products 6a, 6b, the information of the entered correspondence is sent from the terminal device 5 to the server 3. Then, the correspondence memory 32a of the server 3 stores the received information of the correspondence in the server's memory 33 (Step S10). FIG. 5 shows an example of a correspondence 33a. stored in the server's memory 33, among the products, the weight measuring mats, and the location information. The server's memory 33 may further store the weight of each product 6a, 6b in a state of 100%, or the weight per product.

Then, the remaining quantity calculator 32b calculates the remaining quantity (e.g., in percentage or number) of each product 6a, 6b based on the weight data sent from the weight measuring mat 2a, 2b corresponding to the product 6a, 6b, together with the ID information (Step S11). For example, referring to FIG. 5, if the weight of the product a in a state of 100% is 50 kg, and the weight data sent from the weight measuring mat A is 30 kg, the remaining quantity calculator 32b calculates the remaining quantity of the product a to be 60% (30/50×100=60%). Further, referring to FIGS. 5 and 6, if the weight of the product d in a state of 100% is 50 kg, and the weight data sent from the weight measuring mats D and E is 20 kg, the remaining quantity calculator 32b calculates the remaining quantity of the product d to be 80% (20+20)/50×100=80%).

Then, the display controller 32f sends, to the terminal device 5 of the stock keeper, the remaining quantity of each product 6a, 6b calculated by the remaining quantity calculator 32b and the location information of each product 6a, 6b stored in the server's memory 33 so that the terminal's display 55 shows the received information (Step S12).

As an example of Step S12, as shown in FIG. 9, the display controller 32f may display the layout plan 33f illustrating the locations of the products 6a, 6b on the terminal's display 55, together with the remaining quantities of the products 6a, 6b at the locations of the products 6a, 6b on the layout plan based on the location information of the products 6a, 6b stored in the server's memory 33. In the example shown in FIG. 9, the display controller 32f shows a layout plan of the first floor of a target facility on the terminal's display 55. In addition, referring to the correspondence 33a (FIG. 5) stored in the server's memory 33, the display controller 32f shows, on the layout plan, the remaining quantity of the product a (60%) in the first workroom where the product a is stored, and the remaining quantity of the product c (20%) in the second workroom where the product c is stored. This allows the stock keeper to intuitionally check the location of the product c which needs to be replenished.

As a variation of Step S12, as shown in FIG. 10, the display controller 32f may show, on the terminal's display 55, the products 6a, 6b classified by area (floor number in the illustrated example) based on the location information (e.g., the first location information) of each product 6a, 6b stored in the server's memory 33, and the remaining quantities of the products 6a, 6b grouped by area. This allows the stock keeper to collectively check the remaining quantities of the products by area, which can optimize a sales route or a replenishment route.

Subsequently, based on the history 33b of the remaining quantity of each product 6a, 6b, the proper stock quantity calculator 32e calculates an average consumption rate 33m of the product 6a, 6b, and the proper stock quantity calculator 32e calculates, based on the calculated average consumption rate 33, a proper stock quantity 33c (order point) of the product 6a, 6b (Step S13).

FIG. 8 is a flowchart illustrating an example of a step of calculating the proper stock quantity 33c (Step S13). In the example shown in FIG. 8, first, the proper stock quantity calculator 32e calculates an “average quantity used per day (kg),” i.e., the average consumption rate 33m, of each product 6a, 6b based on the history 33b of the remaining quantity of each product 6a, 6b stored in the server's memory 33 (Step S20).

Then, the proper stock quantity calculator 32e calculates a “safe stock quantity (kg)” of each product 6a, 6b based on the history 33b of the remaining quantity of each product 6a, 6b stored in the server's memory 33 (Step S21). Specifically, for example, the replenishment threshold optimizing unit 32e calculates a “standard deviation of the quantity used per day” based on the history 33b of the remaining quantity, and calculates the “safe stock quantity” from a formula: “safe stock quantity (kg)”=“safety coefficient”×“standard deviation of quantity used per day”×√ (“order lead time (day)”+“order interval (day)”).

Then, the proper stock quantity calculator 32e calculates a “proper stock quantity (kg)” from a formula: “proper stock quantity (kg)”=“average quantity used per day (kg)”×“maximum procurement lead time (day)”+“safe stock quantity (kg)” (Step S22). As a result, the proper stock quantity 33c of each product 6a, 6b is optimized in accordance with the history 33b of the remaining quantity of the product, and the timing accuracy of generating the remaining quantity alert in Step S16, which will be described later, can be improved. The proper stock quantity calculator 32e stores the proper stock quantity 33c of each product calculated in this manner in the server's memory 33.

Subsequently, as shown in FIG. 7, the remaining quantity alert generator 32c compares the remaining quantity of each product 6a, 6b calculated by the remaining quantity calculator 32b with the proper stock quantity 33c of the product 6a, 6b stored in the server's memory 33 (Step S14). If the remaining quantity of each product 6a, 6b is less than the proper stock quantity 33c thereof (the answer is YES in Step S15), the remaining quantity alert generator 32c generates a remaining quantity alert about the product 6a, 6b (see FIG. 16). Then, the remaining quantity alert generator 32c refers to the address 33g of the terminal device 5 of the product 6a, 6b stored in the server's memory 33, and sends the remaining quantity alert about the product 6a, 6b to the terminal device 5 of the stock keeper in charge of the product 6a, 6b by e-mail or instant message (Step S16). This allows the stock keeper to quickly become aware of the remaining quantity alert by a ringtone of the terminal device 5, for example.

The display controller 32f highlights the remaining quantity of the product 6a, 6b about which the remaining quantity alert generator 32c has generated the remaining quantity alert (Step S27). In the example shown in FIGS. 9 and 10, the remaining quantity of the product c “20%” is less than the set value of the replenishment threshold for the product c (e.g., 40%). Thus, the remaining quantity alert generator 32c generates a remaining quantity alert about the product c, and the display controller 32f displays (highlights) the background of the remaining quantity of the product c “20%” in a color different from the backgrounds of the remaining quantities of the other products. Thus, the stock keeper who checks the remaining quantity of each product via the terminal's display 55 can easily recognize the product c about which the remaining quantity alert has been generated, and the stock control can be more efficient.

Subsequently, if the stock keeper enters an order request for the product via the terminal's input unit 54 of the terminal device 5, the information of the entered order request is sent from the terminal device 5 to the server 3, and the order request receiving unit 32g of the server 3 receives the order request information (Step S18).

When the order request receiving unit 32g receives the order request for the product 6a, 6b, the product ordering unit 32h automatically places an order for the product 6a, 6b by an order quantity 33e thereof stored in the server's memory 33 to the supplier 33d of the product stored in the server's memory 33 (Step S19). This can greatly save the order-related labor of the stock keeper. The order confirmation generator 33r determines whether the process of ordering the requested product 6a, 6b to the supplier 33d has been succeeded or not. If the process has been succeeded, the order confirmation generator 33r may generate an order confirmation for the product 6a, 6b, and send the order confirmation to the terminal device 5 of the stock keeper in charge of the product 6a, 6b by e-mail or instant message.

In Step S19, when the order request receiving unit 32g receives the order request for the product 6a, 6b, the product ordering unit 32h determines whether the remaining quantity alert has been generated about a different product of the same type as the requested product. If the remaining quantity alert has been generated about the different product of the same type as the requested product, the product ordering unit 32h may collectively place an order of the requested product, and an order of the different product about which the remaining quantity alert has been generated, to the supplier 33d of the requested product. If the products of the same type are collectively ordered, the cost can be reduced by volume discount.

Alternatively, in Step S19, when the order request receiving unit 32g receives the order request for the product 6a, 6b, the product ordering unit 32h may determine whether the remaining quantity alert has been generated about a different product of which the supplier is identical to that of the requested product. If the remaining quantity alert has been generated about the different product of which the supplier is identical to that of the requested product, the product ordering unit 32h may collectively place an order for the requested product, and an order for the different product about which the remaining quantity alert has been generated, to the supplier 33d of the requested product. If the products from the same supplier are collectively ordered, the cost can be reduced by volume discount.

After Step S13 described above, the anomaly detection alert generator 32p may compare the average consumption rate 33m of each product 6a, 6b with a predetermined anomaly detection alert threshold. If the average consumption rate 33m is greater than the anomaly defection alert threshold, the anomaly detection alert generator 32p may generate an anomaly detection alert (see FIG. 16). Thus, if the remaining quantity of the product 6a, 6b suddenly decreases due to leakage or any other cause, the stock keeper in charge of the product 6a, 6b can be quickly informed of the anomaly before the generation of the remaining quantity alert.

Further, after Step S13, the expiration alert generator 32q may compare the average consumption rate 33m of each product 6a, 6b with a predetermined expiration alert threshold. If the average consumption rate 33m is less than the expiration threshold, the expiration alert generator 32q may generate an expiration alert (see FIG. 16). Thus, when the consumption rates of the products 6a, 6b are lower than expected, the stock keeper in charge of the products 6a, 6b can be informed of the possibility that some products have been expired.

### Process of Generating Dead Stock Alert

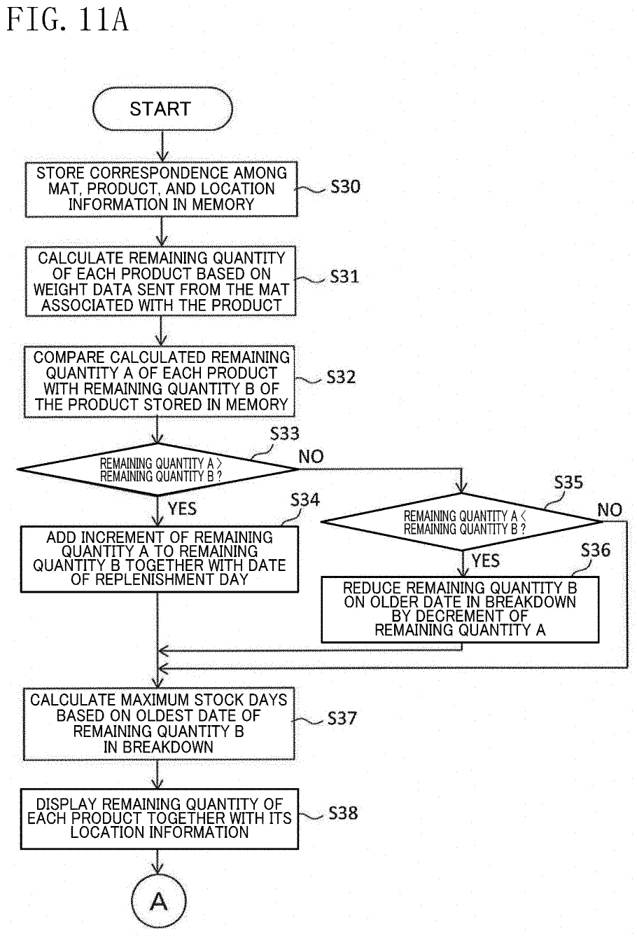

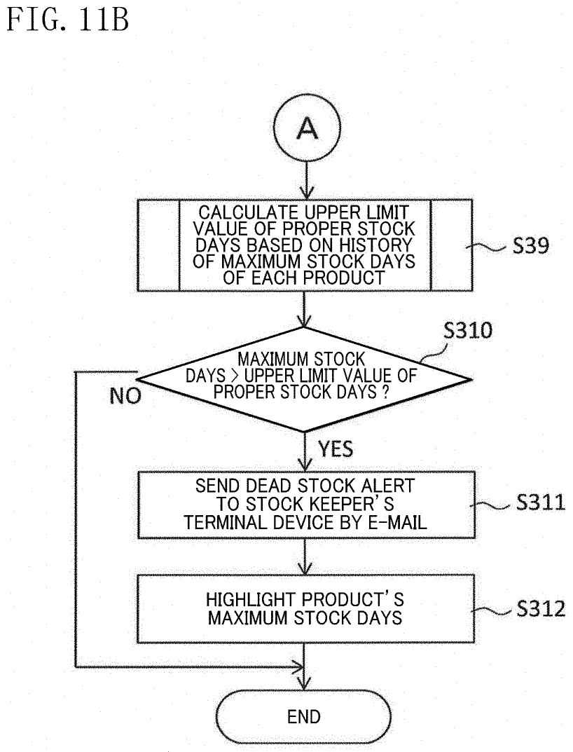

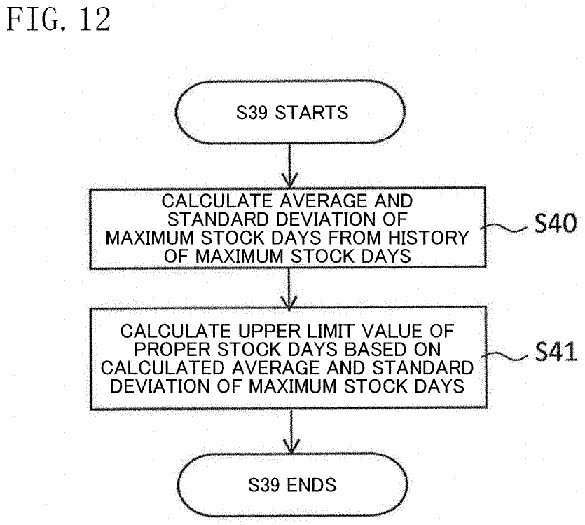

Referring to FIGS. 11A to 15, how the dead stock alert is generated by the information processing system 1 will be described below. FIGS. 11A and 11B are flowcharts illustrating an example of how the dead stock alert is generated by the information processing system 1. FIG. 12 is a flowchart illustrating an example of a step of calculating an upper limit value of the proper stock days. FIG. 13 illustrates the breakdown of the remaining quantity of the product by replenishment day. FIGS. 14 and 15 show an example of a screen displayed when the information processing system 1 generates the dead stock alert.

Referring to FIGS. 11A and 11B, first, the stock keeper in charge of the products 6a, 6b enters, via the terminal's input unit 54 of the terminal device 5, a correspondence among a plurality of weight measuring mats 2a, 2b (ID information of the weight measuring mats 2a, 2b), products placed on the weight measuring mats 2a, 2b, and location information of the products 6a, 6b. Then, the terminal device 5 sends the information of the entered correspondence to the server 3, and the correspondence memory 32a of the server 3 stores the received information of the correspondence in the server's memory 33 (Step S30). FIG. 5 shows an example of a correspondence 33a among the products, the weight measuring mats, and the location information stored in the server's memory 33.

Then, the remaining quantity calculator 32b calculates the remaining quantity of each product 6a, 6b (e.g. in the unit of kg) based on the weight data sent from the weight measuring mat 2a, 2b corresponding to the product 6a, 6b together with the ID information (Step S31). For example, referring to FIG. 5, if the weight data sent from the weight measuring mat A is 30 kg, the remaining quantity calculator 32b calculates the remaining quantity of the product a to be 30 kg. Further, referring to FIGS. 5 and 6, it the weight data sent from the weight measuring mats D and E is 20 kg, the remaining quantity calculator 32b calculates the remaining quantity of the product d to be 40 kg (20+20=40 kg).

Subsequently, the remaining quantity breakdown memory 32i compares the remaining quantity A of the product 6a, 6b calculated by the remaining quantity calculator 32b with the remaining quantity B (i.e., the previous day's remaining quantity) of the product 6a, 6b stored in the server's memory 33 (Step S32). If the remaining quantity A of the product 6a, 6b calculated by the remaining quantity calculator 32b is greater than the remaining quantify B of the product 6a, 6b stored in the server's memory 33, i.e., remaining quantity A>remaining quantity B is met (if the answer is YES in Step S33), the remaining quantity breakdown memory 32i adds the difference (=remaining quantity A−remaining quantity B) to the breakdown 33h of the remaining quantity of the product 6a, 6b, stored in the server's memory 33, together with the date of the replenishment day (Step S34). In the example (b) shown in FIG. 13, the remaining quantity (210 kg) of the product calculated by the remaining quantity calculator 32b on May 9th (5/9) is greater than the remaining quantity (120 kg) of the product as of May 8th (5/8). Thus, the remaining quantity breakdown memory 32i adds the difference (90 kg) to the breakdown 33h of the remaining quantity of the product stored in the server's memory 33 together with the date of the replenishment day, which is May 9th (5/9).

If the remaining quantity A of the product 6a, 6b calculated by the remaining quantity calculator 32b is less than the remaining quantity B of the product 6a, 6b stored in the server's memory 33, i.e., remaining quantity A<remaining quantity B is met (if the answer is NO in Step S33 and YES in Step S35), the remaining quantity breakdown memory 32i reduces the remaining quantity of the product 6a, 6b on the older date in the breakdown 33h stored in the server's memory 33 only by the difference (=remaining quantity B−remaining quantity A). In the example (c) shown in FIG. 13, the remaining quantity (150 kg) of the product calculated by the remaining quantity calculator 32b on May 11th (5/11) is less than the remaining quantity (210 kg) as of May 10th (5/10). Thus, the remaining quantity breakdown memory 32i preferentially reduces the remaining quantity of the product on the oldest date, i.e., May 7th (5/7), in the breakdown stored in the server's memory 33 only by the difference (60 kg).

If the remaining quantity A of the product 6a, 6b calculated by the remaining quantity calculator 32b is equal to the remaining quantity B of the product 6a, 6b stored in the server's memory 33, i.e., remaining quantity A=remaining quantity B is met (if the answer is NO in Steps S33 and S35), the process proceeds to Step S37 without changing the breakdown of the remaining quantity of the product 6a, 6b, stored in the server's memory 33.

The maximum stock day calculator 32j calculates the maximum stock days of the product 6a, 6b based on the oldest date in the breakdown of the remaining quantity of the product 6a, 6b stored in the server's memory 33 (Step S37). In the example (b) shown in FIG. 13, the maximum stock day calculator 32j calculates a difference between the date of the current day (5/9) and the oldest date (5/7) in the breakdown of the remaining quantity of the product stored in the server's memory 33, thereby calculating the maximum stock days to be two days. In the example (c) shown in FIG. 13, the maximum stock day calculator 32j calculates a difference between the date of the current day (5/11) and the oldest date (5/7) in the breakdown of the remaining quantity of the product stored in the server's memory 33, thereby calculating the maximum stock days to be four days.

Then, the display controller 32f sends, to the terminal device 5 of the stock keeper, the maximum stock days of each product 6a, 6b calculated by the maximum stock day calculator 32j and the location information of the product 6a, 6b stored in the server's memory 33 so that the terminal's display 55 shows the received information (Step S38).

As an example of Step S38, as shown in FIG. 14, the display controller 32f may display the layout plan 33f illustrating the locations of the products 6a, 6b on the terminal's display 55, together with the maximum stock days of the products 6a, 6b at the locations of the products 6a, 6b on the layout plan based on the location information of the products 6a, 6b stored in the server's memory 33. In the example shown in FIG. 14, the display controller 32f shows a layout plan of the first floor of a target facility on the terminal's display 55. In addition, referring to the correspondence 33a (FIG. 5) stored in the server's memory 33, the display controller 32f shows, on the layout plan, the remaining quantity of the product a (two days) in the first workroom where the product a is stored, and the remaining quantity of the product c (four days) in the second workroom where the product c is stored. This allows the stock keeper to intuitionally check the location of the product c which may have turned to be a dead stock.

As a variation of Step S38, as shown in FIG. 15, the display controller 32f may show, on the terminal's display 55, the products 6a, 6b classified by area (floor number in the illustrated example) based on the location information (e.g., the first location information) of each product 6a, 6b stored in the server's memory 33, and the maximum stock days of the products 6a, 6b grouped by area. This allows the stock keeper to collectively check the maximum stock days of the products by area, which can optimize a sales route or a dead stock replacement route.

As shown in FIG. 11B, the upper limit calculator 32m calculates an upper limit value 33j of the proper stock days of each product 6a, 6b based on the history 33i of the maximum stock days of each product 6a, 6b (Step S39).

FIG. 12 is a flowchart illustrating an example of a step of calculating the upper limit value 33j of the proper stock days (Step S39). In the example shown in FIG. 12, first, the upper limit calculator 32m calculates an “average of the maximum stock days” and a “standard deviation of the maximum stock days” of each product 6a, 6b based on the history 33i of the maximum stock days of the product 6a, 6b stored in the server's memory 33 (Step S40).

Then, the upper limit calculator 32m calculates an “upper limit value of the proper stock days” from a formula: “upper limit value of the proper stock days”=“average of the maximum stock days”+“standard deviation of the maximum stock days”×α (Step S41). The coefficient α is, for example, any number of 1 to 3 selected in accordance with the rate of occurrence of the dead stock permitted by the stock keeper. As a result, the upper limit value 33i of the proper stock days of each product 6a, 6b is optimized in accordance with the history 33i of the maximum stock days of the product, and the timing accuracy of generating the dead stock alert in Step S311, which will be described later, can be improved. The upper limit calculator 32m stores the calculated upper limit value 33j of the proper stock days of each product in the server's memory 33.

Subsequently, as shown in FIG. 11B, the dead stock alert generator 32k compares the maximum stock days of each product 6a, 6b calculated by the maximum stock day calculator 32j with the upper limit value 33j of the proper stock days of the product 6a, 6b stored in the server's memory 33 (Step S310). If the maximum stock days of the product 6a, 6b has exceeded the upper limit value 33j of the proper stock days of the product (the answer is YES in Step S310), the dead stock alert generator 32k generates a dead stock alert about the product 6a, 6b. Then, the dead stock alert generator 32k refers to the address 33g of the terminal device 5 of the product 6a, 6b stored in the server's memory 33, and sends the dead stock alert about the product 6a, 6b to the terminal device 5 of the stock keeper in charge of the product 6a, 6b by e-mail or instant message (Step S310). This allows the stock keeper to quickly become aware of the dead stock alert by a ringtone of the terminal device 5, for example.

The display controller 32f highlights the maximum stock days of the product 6a, 6b about which the dead stock alert generator 32k has generated the dead stock alert (Step S312). In the example shown in FIGS. 14 and 15, the maximum stock days of the product c “four days” has exceeded the upper limit value of the stock days of the product c (e.g., three days). Thus, the dead stock alert generator 32k generates a dead stock alert about the product c, and the display controller 32f displays (highlights) the background of the maximum stock days of the product c “four days” in a color different from the backgrounds of the remaining quantities of the other products. Thus, the stock keeper who checks the remaining quantity of each product via the terminal's display 55 can easily recognize the product c about which the dead stock alert has been generated, and the stock control can be more efficient.

According to this embodiment, the weight measuring mat 2a, 2b is a general-purpose weight measuring mat, and can be used for stock control. Thus, a general-purpose weight measuring mat usable for stock control can be provided.

According to this embodiment, the weight measuring mat 2a, 2b is in the shape of a flat panel, and the weight of any product can be measured as long as the product can be placed on the flat panel-shaped weight measuring mat. This can provide the weight measuring mat with remarkable general-purpose properties because the type of products 6a, 6b to be measured does not matter.

According to this embodiment, the weight measuring mats 2a, 2b have the standardized planar shape, and a plurality of the weight measuring mats 2a, 2b can be easily placed in combination in the planar direction. This enhances the general-purpose properties of the weight measuring mats.

According to this embodiment, the weight measuring mats 2a, 2b can be combined in the planar direction. Thus, combining the weight measuring mats in the planar direction as shown in FIG. 6 makes it possible to measure the weight of the product, even if it is large in size. This can enhance the general-purpose properties of the weight measuring mat because the type of products to be measured does not matter.

According to this embodiment, the mat's communication unit 21 of the weight measuring mat 2a, 2b can wirelessly communicate, and the battery in the battery compartment 27 supplies the power to the components 21 to 26 of the weight measuring mat. Thus, the weight measuring mat 2a, 2b can be placed and used in a closed space into which a communication cable or a power supply cable cannot be routed. Further, since the housing 20 is in the shape of a flat panel, the weight measuring mat can measure the weight of any product as long as the product can be placed on the flat panel-shaped housing. Therefore, the weight measuring mat can be provided with remarkable general-purpose properties because the installation site and the type of products 6a, 6b to be measured do not matter.

According to this embodiment, even if a user does not instruct the weight measuring mat 2a, 2b each time to measure the weight, the mat's controller 22 acquires measurement data from the weight sensor 24 and sends the data to the server 3 automatically and periodically at the measurement frequency 231 stored in the mat's memory 23. Thus, the weight measuring mat 2a, 2b can be placed and used even in a space which is not easy for the user to access. If the measurement of the weight and the sending of data are performed at a predetermined measurement frequency, power consumption can be further reduced than the case where the measurement of the weight and the sending of data are consecutively performed. This allows the weight measuring mat 2a, 2b to be stably operated for a long time even by a battery.

According to this embodiment, the mat's controller 22 sends the information about the remaining power of the battery in the battery compartment 27 to the server 3. This allows a user to easily check the remaining battery power via the server 3.

According to this embodiment, when the measurement button 25 is pressed, the mat's controller 22 acquires the measurement data from the weight sensor 24 and sends the data to the server 3. Thus, the weight of the product 6a, 6b can be measured at any given time once the user presses the measurement button 25. Further, if the mat's controller 22 has succeeded both of the acquisition of the measurement data and the sending of the data to the server 3, the lamp 26 is lit in a first mode. If the mat's controller 22 has failed one or both of the acquisition of the measurement data and the sending of the data to the server 3, the lamp 26 is lit in a second mode different from the first mode. As a result, the user can tell whether the data has been successfully acquired and sent to the server 3 or not by checking how the lamp 26 is lit. If the lamp 26 is not lit even if the measurement button 25 is pressed, the user can be aware at the battery has gone dead.

According to this embodiment, even if multiple products 6a, 6b are stored in different places, the remaining quantity calculator 32b refers to the correspondence 33a stored in the server's memory 33 to calculate the remaining quantity of each product 6a, 6b based on the weight data sent from the weight measuring mat 2a, 2b associated with the product. Then, the alert generator calculates the consumption rate 33m of each product based on the history 33b of the remaining quantity of each product, and determines when to generate an alert based on the calculated consumption rate of each product 6a, 6b. Thus, stock control of the products 6a, 6b stored in different places can be efficiently performed.

According to this embodiment, what is at least required for the weight measuring mat 2a, 2b is the function of measuring the weight of the product 6a, 6b placed thereon and sending the weight data to the server 3. This can simplify the configuration of the weight measuring mat 2a, 2b, and can reduce the cost for introducing the mat.

According to this embodiment, the product ordering unit 32h automatically places an order for the product in accordance with the order request from the stock keeper in charge of the product 6a, 6b. This can greatly save the order-related labor of the stock keeper.

According to an example of this embodiment, the product ordering unit 32h collectively places the orders for the produce of the same type, and the cost can be reduced by volume discount.

According to another example of this embodiment, the product ordering unit 32h collectively places the orders for the products from the same supplier, and the cost can be reduced by volume discount.

According to an example of this embodiment, the remaining quantities of the products 6a, 6b are shown at the locations of the products 6a, 6b on the layout plan (see FIG. 9). This allows the stock keeper to intuitionally check the location of the product which needs to be replenished.

According to a variation of this embodiment, the remaining quantities of the products 6a, 6b are sorted by area for display (see FIG. 10). As a result, the stock keeper can collectively check the remaining quantities of the products area by area, which can optimize a sales route or a replenishment route.

According to this embodiment, the display controller 32f highlights the remaining quantity of the product 6a, 6b about which the remaining quantity alert generator 32c has generated the remaining quantity alert. Thus, the stock keeper who checks the remaining quantity of each product 6a, 6b can easily recognize the product about which the remaining quantity alert has been generated, and the stock control can be more efficient

According to this embodiment, even if multiple products 6a, 6b are stored in different places, the remaining quantity calculator 32b refers to the correspondence 33a stored in the server's memory 33 to calculate the remaining quantity of each product 6a, 6b based on the weight data sent from the weight measuring mat 2a, 2b associated with the product. Then, the maximum stock day calculator 32j calculates the maximum stock days of each product 6a, 6b based on the calculated remaining quantity of the product 6a, 6b, and the upper limit calculator 32m calculates the upper limit value 33j of the proper stock days based on the history 33i of the maximum stock days of each product. If the maximum stock days of the product 6a, 6b has exceeded the upper limit value 33j of the proper stock days of the product, the dead stock alert generator 32k generates a dead stock alert about the product. Thus, stock control of the products 6a, 6b stored in different places can be efficiently performed.

According to an example of this embodiment, the maximum stock days of the products 6a, 6b are shown at the locations of the products 6a, 6b on the layout plan (see FIG. 14). This allows the stock keeper to intuitionally check the location of the product which may have turned to be a dead stock.

According to a variation of this embodiment, the maximum stock days of the products 6a, 6b are sorted by area for display (see FIG. 15). As a result, the stock keeper can collectively check the maximum stock days of the products area by area, which can optimize a sales route or a dead stock replacement route.

According to this embodiment, the display controller 32f highlights the maximum stock days of the product 6a, 6b about which the dead stock alert generator 32k has generated the dead stock alert. Thus, the stock keeper who checks the maximum stock days of each product 6a, 6b can easily recognize the product about which the dead stock alert has been generated, and the stock control can be more efficient.

The description of the embodiments and the disclosed drawings are merely examples intended to describe the invention recited in claims, and do not limit the invention recited in the claims. Components described in the embodiments can be arbitrarily combined without deviating from the gist of the present disclosure.

In this specification, a “means” is an “object” which is tangible. The weight measuring device according to the embodiment may be a means placed on, or embedded in, a floor or a shelf to measure the weight of an object.

The stock control system according to the embodiment can be implemented by a computer system. Note that a program for causing the computer system to implement the stock control system and a medium recording the program shall be protected by the invention.

### DESCRIPTION OF REFERENCE CHARACTERS

1 Stock Control System
2a, 2b Weight Measuring Device (Weight Measuring Mat)
21 Mat's Communication Unit
22 Mat's Controller
23 Mat's Memory
24 Weight Sensor
25 Measurement Button
26 Lamp
27 Battery Compartment
3 Server
31 Server's Communication Unit
32 Server's Controller
32a Correspondence Memory
32b Remaining Quantity Calculator
32c Remaining Quantity Alert Generator
32d Remaining Quantity History Memory
32c Proper Stock Quantity Calculator
32f Display Controller
32g Order Request Receiving Unit
32h Product Ordering Unit
32i Remaining Quantity Breakdown Memory
32j Maximum Stock Day Calculator
32k Dead Stock Alert Generator
32l Maximum Stock Day History Memory
32m Upper Limit Calculator Calculating Upper Limit Value of Proper Stock Days
32n Battery Alert Generator
32o Communication Alert Generator
32p Anomaly Detection Alert Generator
32q Expiration Alert Generator
33 r Order Confirmation Generator
33 Server's Memory
33a Correspondence among Mat, Product, and Location Information
33b History of Remaining Quantity of Product
33c Proper Stock Quantity of Product
33d Supplier of Product
33e Order Quantity of Product
33f Layout Plan
33g Address of Terminal Device of Stock Keeper
33h Breakdown of Remaining Quantity of Product by Replenishment Day
33i History of Maximum Stock Days of Product
33j Upper Limit Value of Proper Stock Days of Product
33k Remaining Battery Power of Mat
33l Date and Time of Last Communication with Mat
33m Consumption Rate of Product
4 Network
5 Terminal Device of Stock Keeper
51 Terminal's Communication Unit
52 Terminal's Controller
53 Terminal's Memory
54 Terminal's Input Unit
55 Terminal's Display
6a, 6b Product

1. A weight measuring device, comprising
a housing having a flat panel shape;
a weight sensor configured to measure a weight of a product placed on a top of the housing;
a memory configured to store address information of an address of a server on a network; and
processing circuitry configured to
wirelessly communicate with the server on the network;
acquire measurement dam from the weight sensor; and
send the acquired measurement data lo the server using the address information stored in the memory.

2. The weight measuring device according to claim 1, further comprising:
a battery compartment configured to house a battery for supplying power to the weight sensor, the memory, and the processing circuitry.

3. The weight measuring device according to claim 1, wherein the housing includes a mat, and the weight sensor is included in the mat.

4. The weight measuring device according to claim 1, wherein the hosing is configured to be combined with another housing of another weight measuring device in a planar direction.

7. The weight measuring device according to claim 1, wherein
the memory is configured to store a set value of a measurement frequency, and
the processing circuitry is configured to acquire the measurement data from the weight sensor and send the measurement data to the server at the measurement frequency stored in the memory.

8. The weight measuring device according to claim 2, wherein
the processing circuitry is configured to send information about remaining power of the battery housed in the battery compartment to the server.

9. The weight measuring device according to claim 1, further comprising
a measurement button; and
a lamp, wherein
the processing circuitry is configured to:
acquire the measurement data from the weight sensor;
send the measurement data to the server in response to the measurement button being pressed;
light the lamp in a first mode in response to determining that both of the acquisition of the measurement data from the weight sensor and the sending of the measurement data to the server are succeeded; and
light the lamp in a second mode different from the first mode in response to determining that one or both of the acquisition of the measurement data and the sending of the measurement data to the server failed.

10. A stock control server, comprising:
a memory configured to store a correspondence between a plurality of weight measuring devices and a product placed on each of the weight measuring devices; and
processing circuitry configured to
calculate a remaining quantity of each product based on weight data sent from the weight measuring device associated with the product;
calculate a consumption rate of each product based on a history of the remaining quantity of the product; and
determine a timing to generate an alert based on the calculated consumption rate of each product.

11. The stock control server according to claim 10, wherein
the processing circuitry is configured to:
calculate a proper stock quantity of each product based on the consumption rate of the product; and
compare the remaining quantity of the product with the proper stock quantity of the product; and
generate a remaining quantity alert about the product in response to determining that the remaining quantity of the product is smaller than the proper stock quantity of the product.

12. The stock control server according to claim 10, wherein
the processing circuitry is configured to:
compare the consumption rate of the product with an anomaly detection alert threshold for the product; and
generate an anomaly detection alert about the product in response to determining that the consumption rate of the product is greater than the anomaly detection alert threshold.

13. The stock control server according to claim 10, wherein
the processing circuitry is configured to:
compare the consumption rate of each product with an expiration alert threshold for the product; and
generates an expiration alert about the product in response to determining that the consumption rate of the product being less to the expiration alert threshold.

14. The stock control server according to claim 10, wherein
the processing circuitry is configured to:
receive an order request for each product sent from a terminal device of a stock keeper in charge of the products; and
place an order for the product to a supplier of the product stored in the memory in response to receiving the order request for the product.

15. The stock control server according to claim 14, wherein
in response to receiving the order request for the product, the processing circuitry determines whether a remaining quantity alert has been generated about a different product of the same type as the requested product, and
in response to the remaining quantity alert having been generated about the different product of the same type as the requested product, the processing circuitry collectively places an order of the requested product, and an order of the different product about which the remaining quantity alert has been generated, to the supplier.

16. The stock control server according to claim 14, wherein
in response to receiving the order request for the product, the processing circuitry determines whether a remaining quantity alert has been generated about a different product of which a supplier is identical to that of the requested product, and
in response to the remaining quantity alert having been generated about the different product of which the supplier is identical to that of the requested product, the processing circuitry collectively places an order for the requested product, and an order for the different product about which the remaining quantity alert has been generated, to the supplier.

17. The stock control server according to claim 10, wherein
the processing circuitry is configured to control a display to display the remaining quantity of each product together with location information of each product.

18. The stock control server according to claim 17, wherein
the processing circuitry is configured to:
control the display to display a layout plan illustrating locations of the products; and
control the display to display the remaining quantities of the products at the locations of the products on the layout plan based on the location information of each product.

19. The stock control server according to claim 17, wherein
the processing circuitry is configured to control the display to display the products classified by area based on the location information of each product, and the remaining quantities of the products sorted by area.

20. The stock control server according to claim 17, wherein
the processing circuitry is configured to control the display to highlight the remaining quantity of the product about which the processing circuitry has generated the remaining quantity alert.

21. A stock control server, comprising:
a memory configured to store a correspondence between a plurality of weight measuring devices and a product placed on each of the weight measuring devices; and
processing circuitry configured to
calculate a first remaining quantity of each product based on weight data sent from the weight measuring device associated with the product;
store, in the memory, a second remaining quantity of each product together with a breakdown thereof by replenish days of the product;
compare the first remaining quantity of each product with the second remaining quantity thereof stored in the memory;
in response to determining that the first remaining quantity of the product is greater than the second remaining quantity thereof stored in the memory, add a difference between the first remaining quantity and the second remaining quantity to the second remaining quantity stored in the memory together with a date of a replenishment day;
in response to determining that the first remaining quantity of the product is less than the second remaining quantity thereof stored in the memory, reduce the second remaining quantity of the product on an older date in the breakdown stored in the memory by a difference between the second remaining quantity and the first remaining quantity;
calculate maximum stock days of each product based on the oldest date in the breakdown of the second remaining quantity of the product stored in the memory;
calculate an upper limit value of proper stock days of each product based on a history of the maximum stock days of the product;
compare the maximum stock days of each product with the upper limit value of the proper stock days of the product; and
generate a dead stock alert about the product to response to determining that the maximum stock days of the product has exceeded the upper limit value of the proper stock days of the product.

22. The stock control server according to claim 21, wherein
the processing circuitry is configured to display, on a display, the maximum stock days of each product together with its location information.

23. The stock control server according to claim 22, wherein
the processing circuitry is configured to display, on the display, a layout plan illustrating locations of the products, and the remaining quantities of the products at the locations of the products on the layout plan lased on the location information of each product.

24. The stock control server according to claim 22, wherein
the processing circuitry is configured to display, on the display, the products classified by area based on the location information of each product, and the maximum stock days of the products sorted by area.

25. The stock control server according to claim 22, wherein
the processing circuitry is configured to highlight the maximum stock days of the product about which the processing circuitry has generated the dead stock alert.

26. The stock control server according to claim 21, wherein
the second remaining quantity is stored in the memory before the first remaining quantity is calculated.

27. The stock control server according to claim 21, wherein
the second remaining quantity is stored in the memory on a day before a day the first remaining quantity is calculated.
